(19) United States
(12) Patent Application Publication
(10) Pub. No.: US 2012/0101210 A1
(43) Pub. Date: Apr. 26, 2012

(54) NOVEL AQUEOUS 2-COMPONENT PUR COATING SYSTEMS FOR IMPROVED CORROSION PROTECTION

(75) Inventors: Arno Nennemann, Bergisch Gladbach (DE); Oliver Pyrlik, Leverkusen (DE); Hans-Josef Laas, Odenthal (DE); Carmen Imöhl, Solingen (DE); Robert Maleika, Dusseldorf (DE)

(73) Assignee: Bayer MaterialScience AG, Leverkusen (DE)

(21) Appl. No.: 13/259,282

(22) PCT Filed: Mar. 23, 2010
(86) PCT No.: PCT/EP2010/001805

§ 371 Date: Dec. 19, 2011

(30) Foreign Application Priority Data
Mar. 31, 2009 (EP) 09004654.1

(51) Int. Cl. C09D 175/08; C09D 7/12; C09D 167/00; C09D 133/14; C09D 175/04

(52) U.S. Cl. 524/507; 524/558; 524/591; 524/608; 524/539; 524/500

(57) ABSTRACT

The invention relates to novel aqueous two-component coating agents based on hydroxy and/or amino-functional water-dilutable resins and nanoparticle-modified isocyanate-functional curing agents, to a method for the production thereof, and to the use thereof in paints, coatings, and sealants, particularly for corrosion protection applications.

The invention relates to novel aqueous two-component coating compositions based on hydroxy- and/or amino-functional water-dilutable resins and nanoparticle-modified isocyanate-functional curing agents, to a process for their preparation, and to their use in lacquers, coatings and sealants, in particular for anticorrosive applications.

Two-component polyurethane lacquers have become very important in the coatings sector owing to their outstanding properties. A disadvantage is that in most cases relatively large amounts of organic solvents are required for processing. In almost all fields of application, however, high-solids or especially also water-dilutable coating compositions are increasingly required in order to keep solvent emissions and the associated ecological damage as low as possible.

Until several years ago, the use of water as solvent for two-component polyurethane lacquers did not appear readily possible because isocyanate groups can react not only with the hydroxyl groups of the resin to given urethanes but also with water with the formation of urea and carbon dioxide. This generally results in an impairment of the processing time, the ease of application, the achievement of sufficiently blister-free layer thicknesses and the resistance properties of the lacquers and coatings to values that are no longer acceptable in practice.

In recent years, however, attempts have increasingly been made to reduce those problems. A first possible solution is described in EP-A 358 979, in which selected polyhydroxy polyacrylate secondary dispersions are combined with polyisocyanates containing free isocyanate groups to form aqueous two-component systems.

Meanwhile, it has been possible to show that this principle can also be transferred to other hydroxy-functional resin dispersions and, in that manner, the properties of the lacquers can be varied. For example, EP-A 557 844 describes two-component polyurethane coatings based on hydroxy-functional polyacrylate primary dispersions, EP-A 543 228 describes such coatings based on polyester-polyacrylate hybrid dispersions, EP-A 741 176 describes such coatings based on extrinsically emulsified alkyd resins, EP-A 496 205 describes such coatings based on urethane-modified polyester dispersions, or EP-A 542 105 describes such coatings based on mixtures of different types of resin.

Both hydrophobic and hydrophilic, self-emulsifying polyisocyanates can be used as the polyisocyanate component in the aqueous two-component polyurethane systems. While the use of low-viscosity, hydrophobic polyisocyanates leads to coatings having very high resistance, hydrophilic crosslinkers, for example polyisocyanates hydrophilically modified by reaction with polyether alcohols, as are described in EP-A 0 206 059, EP-A 0 540 985 or U.S. Pat. No. 5,200,489, or sulfonate-group-containing polyisocyanates of the type described in WO 01/88006, have advantages as regards dispersibility and ease of application.

From DE 10 2006 054289 and EP 07021690.2 there are known colloidally stable, transparent or translucent nanoparticle-containing polyisocyanates which are obtained by modifying polyisocyanates with aminoalkoxysilanes or with aminoalkoxysilanes and polydimethylsiloxanes and adding nanoparticles. However, hydrophilic polyisocyanates for use in aqueous dispersions are not described. Their use in aqueous coating compositions for anticorrosive applications is also not described.

Good corrosion protection is generally difficult to achieve in aqueous polyurethane coatings because water and electrolyte transportation, and therefore corrosion, is promoted on account of the high system-inherent hydrophilicity of the coating raw materials.

Accordingly, it was an object of the invention to provide novel aqueous two-component polyurethane coatings which have improved corrosion protection while having high ease of application. The novel coating systems are to be suitable in particular for use in the fields of automotive repair lacquering, large vehicle lacquering and general industrial lacquering. They can be used as optionally pigmented base coats/primers/adhesion promoters, fillers, covering lacquers and also as clear lacquers.

Surprisingly, it has been possible to achieve that object with the provision of the coating compositions, described in greater detail hereinbelow, based on hydroxy- and/or amino-functional water-dilutable resins and nanoparticle-modified isocyanate-functional curing agents, or of the process for the preparation of such coating compositions.

The present invention provides coating compositions comprising
A) from 10 to 90 wt. % of an aqueous, hydroxy- and/or amino-functional resin dispersion,
B) from 10 to 90 wt. % of a nanoparticle-modified polyisocyanate, and
C) from 0 to 60 wt. % of further auxiliary substances and additives known in lacquer technology,
   the percentages being based on solids in the total composition.

The invention also provides a process for the preparation of such aqueous coating compositions and their use in lacquers, coatings, primers and sealants, in particular for anticorrosive applications.

There can be used as component A) in the coating compositions according to the invention all resin dispersions conventional in aqueous two-component polyurethane coatings technology. Such resin dispersions and processes for their preparation are known. They are, for example, conventional aqueous or water-dispersible polyester resins, polyacrylate resins, polyurethane resins, polyurea resins, polycarbonate resins or polyether resins, as are described, for example, in EP-A 358 979, EP-A 469 389, EP-A 496 205, EP-A 557 844, EP-A 583 728, WO 94/03511, WO 94/20559, WO 94/28043 or WO 95/02005. The use of arbitrary hybrid dispersions or arbitrary mixtures of different dispersions is also possible.

Suitable secondary, hydroxy-functional polyacrylate dispersions A1) are obtained by copolymerisation of unsaturated compounds (monomers) in solvents, neutralisation of incorporated potentially ionic groups, and dispersion in water.

Monomers suitable for the preparation of secondary polyacrylate dispersions A1) are, for example, carboxy-functional radically polymerisable monomers such as, for example, acrylic acid, methacrylic acid, β-carboxyethyl acrylate, crotonic acid, fumaric acid, maleic acid (anhydride), itaconic acid or monoalkyl esters of dibasic acids or anhydrides, such as, for example, maleic acid monoalkyl esters. Acrylic acid or methacrylic acid is preferably used.

Suitable non-functional monomers are cyclohexyl(meth)acrylate, cyclohexyl (meth)acrylates substituted by alkyl groups on the ring, 4-tert-butylcyclohexyl (meth)acrylate, norbornyl(meth)acrylate, isobornyl(meth)acrylate, (meth)acrylic acid esters having C1-C18-hydrocarbon radicals in the alcohol moiety, for example ethyl acrylate, ethyl methacrylate, n-butyl acrylate, n-butyl methacrylate, isobutyl acrylate, isobutyl methacrylate, 2-ethylhexyl acrylate, methyl methacrylate, 2-ethylhexyl methacrylate, tert-butyl acrylate, stearyl acrylate, stearyl methacrylate, norbornyl acrylate and/or norbornyl methacrylate.

Suitable hydroxy-functional monomers are, for example, OH-functional (meth)acrylic acid esters having C1-C18-hydrocarbon radicals in the alcohol moiety, such as, for example, hydroxyethyl methacrylate, hydroxypropyl methacrylate, hydroxyethyl acrylate, hydroxypropyl acrylate, hydroxybutyl acrylate or hydroxybutyl methacrylate.

Also suitable are hydroxy monomers containing alkylene oxide units, such as, for example, addition products of ethylene oxide, propylene oxide or butylene oxide with (meth)acrylic acid. Hydroxyethyl methacrylate and/or hydroxypropyl methacrylate is preferred.

Also suitable are styrene, vinyltoluene, α-methylstyrene, vinyl esters, vinyl monomers containing alkylene oxide units, such as, for example, condensation products of (meth)acrylic acid with oligoalkylene oxide monoalkyl ethers, as well as optionally monomers having further functional groups, such as, for example, epoxy groups, alkoxysilyl groups, urea groups, urethane groups, amide groups or nitrile groups. Di- or higher-functional (meth)acrylate monomers and/or vinyl monomers, such as, for example, hexanediol di(meth)acrylate, can also be used in amounts of from 0 to 3 wt. %, based on the sum of the monomers.

Further monomers can optionally also be used. There are suitable, for example, unsaturated radically polymerisable compounds having phosphate or phosphonate groups or sulfonic acid or sulfonate groups.

Preferred monomers are methyl methacrylate, styrene, acrylic acid, methacrylic acid, butyl acrylate, butyl methacrylate, ethyl acrylate, tert-butyl acrylate, 2-ethylhexyl acrylate, 2-ethylhexyl methacrylate, hydroxyethyl methacrylate, hydroxypropyl methacrylate, hydroxyethyl acrylate, hydroxypropyl acrylate, hydroxybutyl acrylate or hydroxybutyl methacrylate.

In the secondary polyacrylate dispersions A1), the amount of carboxy-functional monomers is from 0.8 to 5 wt. %, preferably from 1.2 to 4 wt. %, and the amount of hydroxy-functional monomers is from 1 to 45 wt. %, preferably from 6 to 30 wt. %.

Suitable polymerisation initiators are peroxy compounds such as diacyl peroxides, alkyl peresters, dialkyl peroxides, peroxide dicarbonates, inorganic peroxides, or also azo compounds.

In principle, any organic solvents are suitable for the preparation of the polyacrylates. The solvents can be used in any desired amounts, preferably in amounts of <20 wt. %, based on the total sum of the monomers, in order to obtain low solvent contents in the dispersion. Preference is given to a solvent mixture of a hydrophobic solvent, such as, for example, solvent naphtha, toluene, xylene, white spirit, and a hydrophilic solvent, such as, for example, butyl glycol, butyl diglycol, diethylene glycol, propylene glycol monomethyl ether or dipropylene glycol monomethyl ether.

The preparation of the secondary polyacrylate dispersions can in principle be carried out according to any process known in the prior art, for example by fed-batch processes, batch processes or also by cascade processes.

Preferred secondary, hydroxy-functional polyacrylate dispersions A1) are obtainable by reaction of a mixture of
a) from 0 to 85 wt. % (meth)acrylic acid esters having C1 to C18 aliphatic hydrocarbon radicals in the alcohol moiety and/or vinyl aromatic compounds,
b) from 5 to 35 wt. % hydroxy-functional (meth)acrylic acid esters, which are reacted to give a hydrophobic polymer, wherein, following the addition of a) and b), a mixture of
c) from 4 to 20 wt. % (meth)acrylic acid esters having C1 to C18 aliphatic hydrocarbon radicals in the alcohol moiety and/or vinyl aromatic compounds,
d) from 4 to 15 wt. % hydroxy-functional (meth)acrylic acid esters and
e) from 1 to 5 wt. % acid-functional monomers, such as acrylic acid or methacrylic acid, is metered in and polymerised to a hydrophilic polymer, wherein in parallel with the addition of a), b), c), d) and e) initiators are metered in amounts of from 0.5 to 6.5 wt. % and the sum of the percentages of a), b), c), d) and e) is 100 wt. %.

There is preferably used as solvent a mixture of a hydrophilic solvent, for example butyl glycol, and a hydrophobic solvent, for example solvent naphtha.

When the polymerisation reaction is complete, the polymer solution is dispersed in water or by addition of water. The neutralisation of the acid groups with amine(s) and/or bases, and accordingly their conversion into salt groups, can be carried out prior to the dispersion or in parallel by addition of the neutralising amine together with the dispersing water or by addition in parallel with the dispersing water. The degree of neutralisation can be from 50 to 150%, preferably from 60 to 120%.

After the dispersion, some or all of the solvent used can be removed by distillation.

Preferred neutralising amines are dimethylethanolamine, ethyldiisopropylamine, methyldiethanolamine and 2-aminomethyl-2-methyl-propanol.

The pH value of the secondary polyacrylate dispersions is from 5 to 11, preferably from 6 to 10. The solids contents are from 20 to 60 wt. %, preferably from 35 to 55 wt. %. The mean particle sizes of the dispersion are from 20 to 400 nm.

In the preparation of the secondary polyacrylate dispersions it is also possible to use so-called reactive diluents instead of the solvents or together with the solvents. Suitable reactive diluents are, for example, di- and/or tri-functional polyethers that are liquid at room temperature, low-viscosity polyesters such as reaction products of 1 mol of a dicarboxylic acid, such as, for example, dimer fatty acids or adipic acid, with 2 mol of a diol or triol or 2 mol of Cardura® E 10 (glycidyl ester of versatic acid, Hexion Specialties USA). Also suitable as reactive diluents are reaction products of caprolactone with low molecular weight alcohols. Castor oil and other hydroxy-functional oils are also suitable.

Suitable hydroxy-functional polyacrylate emulsions A1) are those which are prepared by known copolymerisation processes in aqueous emulsion in the presence of suitable surface-active substances. Polyacrylate emulsions and their preparation are described, for example, in R. O. Athey jr., Emulsion Polymer Technology, Dekker, New York, 1991.

The monomers mentioned in the preparation of the secondary polyacrylate dispersions are in principle also suitable for the preparation of polyacrylate emulsions.

Initiators are either placed in the reaction vessel and/or added in parallel, optionally in advance or with a time delay and/or time lag. Suitable initiators are, for example, redox systems, peroxides, persulfates and/or azo compounds such as dibenzoyl peroxide, dicumene peroxide, cumene hydroperoxide, potassium peroxodisulfate, ammonium peroxodisulfate, azobisisobutyronitrile or di-tert-butyl peroxide. Iron(II) ions, for example, can be added as redox initiators.

Preferred polyacrylate emulsions A1) are obtained by emulsion polymerisation, in water in the presence of initiators and surface-active substances, of a) from 10 to 40 wt. % hydroxy-functional (meth)acrylic acid esters, b) from 40 to 90 wt. % (meth)acrylic acid esters having aliphatic C1- to C18-hydrocarbon radicals in the alcohol moiety and/or vinyl aromatic compounds, c) from 0 to 5 wt. % acid-functional monomers, such as acrylic acid or methacrylic acid, d) from 0 to 25 wt. % of other monomers such as, for example, acrylonitrile, vinyl acetate, vinylpyrrolidone.

Mixed forms of polyacrylate dispersions, such as, for example, polyester/polyacrylate dispersions, are also suitable as component A1). These contain both polyacrylate and polyester segments and are prepared, for example, by carrying out, in the presence of polyester, a radical (co)polymerisation of monomers corresponding to those mentioned in the preparation of secondary polyacrylate dispersions.

This reaction is carried out without a solvent or, preferably, in organic solution. The polyester acrylate thereby contains from 10 to 75 wt. %, preferably from 20 to 60 wt. %, polyester components.

Preferred hydroxy-functional polyester/polyacrylate dispersions are obtained by a radically initiated polymerisation of a mixture of a) from 20 to 70 wt. % (meth)acrylic acid esters having aliphatic C1- to C18-hydrocarbon radicals in the alcohol moiety and/or vinyl aromatic compounds, b) from 3 to 35 wt. % hydroxy-functional (meth)acrylic acid esters, c) from 2 to 8 wt. % acid-functional monomers, such as acrylic acid or methacrylic acid, in the presence of d) from 75 to 10 wt. % of a hydroxy-functional polyester which optionally contains groups rendered capable of graft polymerisation by incorporation of components containing double bonds.

Preferred initiators are di-tert-butyl peroxide and tert-butyl peroctoate. The initiators are used in amounts of from 0.5 to 5 wt. %. The reaction is carried out at from 90 to 180° C.

The incorporated acid groups are reacted partially or completely with neutralising amines, preference being given to dimethylethanolamine, ethyldiisopropylamine or 2-aminomethyl-2-methylpropanol. Dispersion in or with water is then carried out.

Suitable polyurethane dispersions A2) are generally self-emulsifying polyurethanes or polyurethane polyureas in aqueous form which are known per se.

The polyurethanes become self-emulsifying by incorporation of ionic and/or non-ionically hydrophilising groups into the polymer chain. The incorporation of the hydrophilic groups is possible in many different ways; for example, hydrophilic groups can be incorporated directly into the polymer chain or they can be attached laterally or terminally.

Suitable polyurethane dispersions can be prepared in the melt or in organic solution by preparation processes known to the person skilled in the art and then dispersed, it being possible for the so-called chain extension reaction for building up the molecular weight optionally to be carried out in organic solution, in parallel with the dispersing step or after the dispersing step.

The following raw materials are usually used or reacted with one another in order to prepare suitable polyurethane dispersions A2):
1) At least one NCO-reactive structural unit for incorporating hydrophilic groups into the polyurethane, such as hydroxycarboxylic acids, for example dimethylolacetic acid, 2,2-dimethylolpropionic acid, 2,2-dimethylbutyric acid, 2,2-dimethylolpentanoic acid, dihydroxysuccinic acid, hydroxypivalic acid or mixtures of such acids, hydroxysulfonic acids, aminocarboxylic acids such as, for example, the Michael adducts of isophoronediamine or ethylenediamine with acrylic acid, aminosulfonic acids such as, for example, aminoethylethanesulfonic acid, hydroxy- or amino-functional phosphonic acids and/or mono-, di- or tri-functional polyethylene oxide structural units of the molecular weight range from 350 to 2500 g/mol, it also being possible to use mixtures of different hydrophilising agents. Component 1) is used in amounts such that stable aqueous dispersions are obtained.
Particularly suitable NCO-reactive structural units for incorporating hydrophilic groups are dimethylolpropionic acid, dimethylolbutyric acid, mono- or di-hydroxy-functional polyethylene oxide structural units of the molecular weight range from 350 to 2500, such as, for example, polyether LB 25® (monohydroxy-functional polyether based on ethylene oxide, Bayer MaterialScience AG, DE), Carbowax® 750 (monohydroxy-functional polyether based on ethylene oxide, Dow Chemicals, USA), Pluriol® A 500 (monohydroxy-functional polyether based on ethylene oxide, BASF AG, Ludwigshafen, Germany), and hydroxy- or amino-functional sulfonic acids or sulfonates.
2) At least one aliphatic and/or aromatic di- or poly-isocyanate, for example di- or tri-functional aliphatic isocyanates such as hexamethylene diisocyanate, butane diisocyanate, isophorone diisocyanate, 1-methyl-2,4(2,6)-diisocyanatocyclohexane, norbornane diisocyanate, xylylene diisocyanate, tetramethylxylylene diisocyanate, hexahydroxylylene diisocyanate, nonane triisocyanate, 4,4′-diisocyanatodicyclohexyl-methane. Also suitable is the concomitant use of aromatic isocyanates such as, for example, 2,4(2,6)-diisocyanatotoluene or 4,4′-diisocyanatodiphenylmethane as well as higher molecular weight or oligomeric polyisocyanates of the molecular weight range from 336 to 1500 based on the above-mentioned aliphatic isocyanates. Preference is given to the use of 4,4′-diisocyanatodicyclohexylmethane and/or isophorone diisocyanate and/or hexamethylene diisocyanate and/or 1-methyl-2,4(2,6)-diisocyanato-cyclohexane. Particular preference is given to the use of isophorone diisocyanate and/or hexamethylene diisocyanate or of mixtures of 4,4′-diisocyanatodicyclohexylmethane with isophorone diisocyanate or hexamethylene diisocyanate.
3) At least one polyol component of the molecular weight range from 500 to 18,000 g/mol based on polyester, polyamide, polyacetal, polyether and/or polysiloxane and/or polycarbonate having a functionality of from 1 to 5, preferably from 2 to 2.5.

Suitable polyol components 3) for the preparation of the polyurethane dispersions A2) can be: polyester polyols having a mean functionality of from 1.5 to 5. There come into consideration in particular linear polyester diols or also weakly branched polyester polyols, as can be prepared in known manner from aliphatic, cycloaliphatic or aromatic di- or poly-carboxylic acids or their anhydrides, such as, for example, succinic acid, glutaric acid, maleic acid, fumaric acid, adipic acid, pimelic acid, suberic acid, azelaic acid, sebacic acid, nonanedicarboxylic acid, decanedicarboxylic acid, dimer fatty acid, terephthalic acid, isophthalic acid, o-phthalic acid, tetrahydrophthalic acid, hexahydrophthalic acid or trimellitic acid or a mixture thereof, or mixtures of the mentioned di- or poly-carboxylic acids with other di- or poly-carboxylic acids with polyhydric alcohols, such as, for example, ethanediol, di-, tri-, tetra-ethylene glycol, 1,2-propanediol, di-, tri-, tetra-propylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol or mixtures thereof, optionally with the concomitant use of higher functional polyols such as trimethylolpropane or glycerol. Suitable polyhydric alcohols for the preparation of the polyester polyols are, of course, also cycloaliphatic and/or aromatic di- and poly-hydroxyl compounds. Instead of the free polycarboxylic acids, the corresponding polycarboxylic acid anhydrides or corresponding polycarboxylic acid esters of lower alcohols or mixtures thereof can also be used to prepare the polyesters.

The proportionate concomitant use of monofunctional carboxylic acids, such as, for example, benzoic acid, ethylhexanoic acid, soybean fatty acid, groundnut oil fatty acid, oleic acid, saturated C12-C20 fatty acids or mixtures thereof, as well as cyclohexanol, isooctanol and fatty alcohols, is also possible.

The polyester polyols can, of course, also be homopolymers or mixed polymers of lactones, which are preferably obtained by addition of lactones or lactone mixtures, such as butyrolactone, ε-caprolactone and/or methyl-ε-caprolactone, to suitable di- and/or higher-functional starter molecules, such as, for example, the low molecular weight, polyhydric alcohols mentioned above as structural components for polyester polyols. The corresponding polymers of s-caprolactone are particularly preferred.

Hydroxyl-group-containing polycarbonates also come into consideration as polyhydroxyl components, for example those which can be prepared by reaction of diols such as 1,4-butanediol and/or 1,6-hexanediol and/or pentanediol with diaryl carbonates, for example diphenyl carbonate, or phosgene.

There may be mentioned as polyether polyols, for example, the polyaddition products of the styrene oxides, of ethylene oxide, propylene oxide, tetrahydrofuran, butylene oxide, epichlorohydrin, as well as their mixed addition and graft products, as well as the polyether polyols obtained by condensation of polyhydric alcohols or mixtures thereof and those obtained by alkoxylation of polyhydric alcohols, amines and amino alcohols.

Block copolymers based on the mentioned polyols, such as, for example, polyether-polyester or polycarbonate-polyester or polycarbonate-polyether, can also be used.

Preference is given to the use of polyester polyols and/or polycarbonate polyols and/or C3- or C4-polyether polyols. The use of a combination of polyester polyol and polycarbonate polyol or polycarbonate polyol and C4-polyether polyol is particularly preferred.
4) Optionally low molecular weight (molecular weight <500 g/mol) diols, triols or tetraols, such as, for example, 1,4-butanediol, 1,6-hexanediol, ethylene glycol, trimethylolpropane, neopentyl glycol, glycerol, pentaerythritol or/and amino alcohols such as, for example, diethanolamine, ethanolamine, diisopropanolamine, propanolamine, optionally also in ethoxylated and/or propoxylated form.
5) Optionally so-called chain extenders such as, for example, di- and/or poly-amines and/or amino alcohols, such as, for example, diethanolamine, 1,2-diaminopropane, 1,4-diaminobutane, 2,5-diamino-2,5-dimethylhexane, 1,5-diamino-2-methylpentane (Dytek® A, DuPont), 1,6-diaminohexane, 2,2,4- and/or 2,4,4-trimethyl-1,6-diamino-hexane, 1,11-diaminoundecane, 1,12-diaminododecane or triaminononane, ethylenediamine, isophoronediamine, diethylenetriamine, hydrazine, adipic acid dihydrazide, hydroxyethyl ethylenediamine, bishydroxyethylethylenediamine, aminopropanol, aminoalkoxysilanes or mixtures thereof. Chain extension can also be carried out by partial or complete reaction of the NCO groups of the prepolymers obtained from 1), 2), 3) and 4) with water.

Preferred polyurethane dispersions A2) contain as structural components 1) from 0.5 to 10 wt. % of at least one NCO-reactive structural unit having at least one hydrophilic group, 2) from 8 to 60 wt. % aliphatic or cycloaliphatic di- or poly-isocyanates, 3) from 20 to 90 wt. % of at least one polyol component of the molecular weight range from 500 to 18,000 g/mol having a mean functionality of from 2 to 3, 4) from 0 to 8 wt. % low molecular weight diols and/or triols, and 5) from 0 to 6 wt. % diamines and/or hydrazine or hydrazides and/or amino alcohols and/or water as chain extender.

Particularly preferred polyurethane dispersions A2) contain as structural components 1) from 1.4 to 6.5 wt. % of at least one NCO-reactive structural unit having at least one carboxyl or carboxylate and/or sulfonate group, optionally in combination with a polyethylene oxide structural unit of the molecular weight range from 350 to 2500 g/mol, 2) from 15 to 50 wt. % aliphatic and/or cycloaliphatic diisocyanates, 3) from 40 to 83 wt. % of at least one polyol component of the molecular weight range from 800 to 2400 g/mol based on a polyester and/or polycarbonate and/or C3- or C4-ether, 4) from 0 to 4 wt. % low molecular weight diols and/or triols such as hexanediol, butanediol, ethylene glycol, glycerol, trimethylolpropane and reaction products thereof with from 1 to 6 mol of ethylene oxide and/or propylene oxide, and 5) from 0 to 4 wt. % diamines and/or hydrazine or hydrazides and/or amino alcohols and/or water as chain extender, wherein neutralising agents for the carboxyl and/or sulfonic acid groups are present in amounts of from 50 to 150 equivalents.

In the preparation of the polyurethane dispersions in the melt or in organic solution, structural units 1), 2), 3) and optionally 4) are usually reacted to an isocyanate-functional prepolymer, it being possible for that reaction to be carried out in one reaction step or optionally also in a plurality of successive reaction steps, the isocyanate-functional prepolymer then being reacted either in the melt, in organic solution or in aqueous dispersion with chain extender 5) to give a high molecular weight polyurethane dispersed or dispersible in water. Some or all of the solvent used is then optionally removed by distillation. Suitable neutralising amines are, for example, the amines mentioned in the preparation of the secondary polyacrylate dispersions, whereby isocyanate-reactive neutralising agents should only be added after the chain extension reaction and complete reaction of the isocyanate groups. Suitable solvents are, for example, acetone or methyl ethyl ketone, which are usually distilled off, N-methylpyrrolidone or N-ethylpyrrolidone.

The reactions can also be carried out using catalysts conventional in polyurethane chemistry, such as, for example, dibutyltin dilaurate, dibutyltin oxide, tin dioctoate, tin chloride, tertiary amines, in order to accelerate the reactions or to achieve special effects. The polyurethane dispersions A2) present in the binder combination according to the invention usually have solids contents of from 25 to 60 wt. %, pH values of from 5.5 to 11 and mean particle sizes of from 20 to 500 nm.

Suitable hydroxy-functional polyester-polyurethane dispersions A3) are reaction products of

1) from 2 to 7 wt. %, preferably from 2 to 5 wt. %, dimethylolpropionic acid and/or hydroxypivalic acid, optionally in combination with mono-, di-functional polyethylene oxide structural units such as, preferably monohydroxy-functional polyethers based on ethylene oxide or methoxy polyethylene glycols,
2) from 7 to 30 wt. %, preferably from 8 to 22 wt. %, of a mixture containing 1,6-hexamethylene diisocyanate and/or bis-(4-isocyanatocyclohexane)-methane and/or 1-methyl-2,4(2,6)-diisocyanatocyclohexane and/or 1-isocyanato-3,3,5-trimethyl-5-isocyanatomethylcyclohexane,
3) from 60 to 91 wt. %, preferably from 70 to 88 wt. %, polyol components of the molecular weight range from 500 to 8000 g/mol based on polyester, polyester amide, polyacetal, polyether, polysiloxane and/or polycarbonate having a functionality of from 1.8 to 5, preferably from 2 to 4, wherein 50 wt. %, preferably 75 wt. %, particularly preferably 100 wt. %, of the polyol component consists of at least one polyester, and
4) from 0 to 5 wt. % low molecular weight (molecular weight<500 g/mol) diols, triols, tetraols and/or amino alcohols.

The reaction of the components takes place in organic solution or in the melt, optionally using catalysts conventional in polyurethane chemistry or/and in the presence of non-reactive amines that act as neutralising agents, such as, for example, triethylamine, ethyldiisopropylamine, N-methylmorpholine, to give hydroxy-functional polyester-polyurethanes which, after the reaction of components 1), 2), 3) and 4), do not contain free isocyanate groups.

Dispersion in or with water is then carried out, and excess solvent is optionally distilled off again.

Suitable neutralising agents, which can be added before or during the dispersing step, are, for example, diethanolamine, dimethylethanolamine, methyldiethanolamine, ammonia or those which have been mentioned in the preparation of the secondary polyacrylate dispersions.

Polyester-polyurethane dispersions A3) have solids contents of from 25 to 55 wt. %, pH values of from 6 to 11 and mean particle sizes of from 10 to 350 nm.

A further suitable component A) can be a water-dilutable, hydroxy-functional polyester resin A4).

Water-dilutable polyesters suitable as component A4) are dispersing resins which have very good pigment wetting or pigment affinity. Component A4) has acid numbers in the range from 25 to 75 mg KOH/g substance and/or hydroxyl group contents of from 2.5 to 10 wt. % and/or molecular weights in the range from 750 to 5000 g/mol and/or fatty acid constituents in amounts of from 15 to 50 wt. %.

Preferred as dispersing resins A4) are water-dilutable polyesters prepared by reaction of
1) from 30 to 62 wt. % diols selected from the group hexanediol, neopentyl glycol, diethylene glycol, ethylene glycol, propane-1,2-diol, propane-1,3-diol and/or 1-butanediol, with
2) from 5 to 20 wt. % triols and/or tetraols selected from the group trimethylolpropane, glycerol and/or pentaerythritol, with
3) from 30 to 62 wt. % dicarboxylic acids selected from the group phthalic anhydride, isophthalic acid, hexahydrophthalic acid, tetrahydrophthalic acid and/or adipic acid, subsequent reaction of the polyester with
4) from 3 to 15 wt. % of an anhydride, preferably trimellitic anhydride, wherein the sum of the percentages is 100 wt. %, and some or all of the acid groups are converted into the salt form by reaction with neutralising agents.

Suitable polyester dispersions or solutions A4) are obtained by reacting hydroxy-functional polyesters, prepared by reaction of mono-, di- and/or higher-functional alcohols and carboxylic acids or their anhydrides with the cleavage of water, with acid anhydrides such as, for example, phthalic anhydride, hexahydrophthalic anhydride, tetrahydrophthalic anhydride, maleic anhydride, trimellitic anhydride, pyromellitic anhydride, at from 60 to 200° C., preferably at from 120 to 180° C., in such a manner that the acid anhydrides are reacted with some of the hydroxyl groups with ring opening of the anhydride and incorporation into the polyester. There are thus obtained hydroxy- and carboxy-functional polyesters which, after partial or complete neutralisation of the carboxyl groups, can be dispersed or dissolved in water. The aqueous polyester solutions have mean particle sizes of from 10 to 200 nm, preferably from 25 to 100 nm.

Suitable raw materials for the preparation of the hydroxy-functional polyesters are, for example, diols such as ethylene glycol, butylene glycol, diethylene glycol, triethylene glycol, polyalkylene glycols such as polyethylene glycol, also propanediol, 1,4-butanediol, 1,6-hexanediol, neopentyl glycol or hydroxypivalic acid neopentyl glycol ester, the three last-mentioned compounds being preferred. There may be mentioned as polyols which are optionally to be used concomitantly, for example, trimethylolpropane, glycerol, erythritol, pentaerythritol, trimethylolbenzene or trishydroxyethyl isocyanurate. Suitable di- and poly-carboxylic acids are, for example: phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid, trimellitic acid or pyromellitic acid. Anhydrides of those acids can likewise be used, where they exist. For the purposes of the present invention, the anhydrides are consequently included in the term “acid”. Monocarboxylic acids can also be used concomitantly. Suitable monocarboxylic acids are, for example, coconut oil fatty acid, soybean oil fatty acid, safflower oil fatty acid, castor oil fatty acid, ricinenic acid, groundnut oil fatty acid, tall oil fatty acid or conjuenic fatty acid, benzoic acid, tert-butylbenzoic acid, hexahydrobenzoic acid, 2-ethylhexanoic acid, isononanoic acid, decanoic acid or octadecanoic acid.

ε-Caprolactone can also be used concomitantly in the preparation of the polyesters.

The hydroxy-functional polyesters are prepared by polycondensation of the mentioned raw materials, optionally using suitable transesterification catalysts, and then reacted with an acid anhydride. The polyester so prepared is dissolved in a solvent or solvent mixture, and neutralising agent is added thereto.

Dispersing or dissolving in water can be carried out directly after preparation of the polyester and reaction with the acid anhydride, or later.

A preferred polyester composition for a polyester dispersion or solution A4) is composed of
a) from 30 to 62 wt. %, preferably from 30 to 50 wt. %, diols selected from the group hexanediol, butanediol, ethylene glycol, diethylene glycol and/or neopentyl glycol,
b) from 50 to 20 wt. %, preferably from 6 to 15 wt. %, triols and/or tetraols, preferably trimethylolpropane and/or glycerol,
c) from 30 to 62 wt. %, preferably from 33 to 58 wt. %, dicarboxylic acids or their anhydrides selected from the group phthalic anhydride, isophthalic acid, tetrahydrophthalic acid, terephthalic acid and/or adipic acid,
d) from 0 to 30 wt. %, preferably from 0 to 20 wt. %, monocarboxylic acids and/or caprolactone, as well as
e) from 3 to 15 wt. %, preferably from 5 to 12 wt. %, acid anhydride selected from the group trimellitic anhydride, tetrahydrophthalic anhydride and/or phthalic anhydride.

The polyurethane dispersions A2) usually have mean molecular weights Mn, which can be determined by gel chromatography, of >10,000 g/mol, preferably >30,000 g/mol. The polyurethane dispersions frequently contain an amount of very high molecular weight components no longer completely soluble in organic solvents, which then evade a molecular weight determination.

The polyester-polyurethane dispersions A3) usually have mean molecular weights Mn, which can be determined, for example, by gel chromatography, of from 1500 to 8000 g/mol.

The polyester dispersions or solutions A4) usually have mean molecular weights Mw, which can be determined, for example, by gel chromatography, of from 7500 to 5000 g/mol, preferably from 1000 to 3500 g/mol.

Of particular interest as regards the level of requirements in the field of automotive repair lacquering and large vehicle lacquering are resin dispersions based on polymers. Therefore, polyacrylate-based resin dispersions A1) are preferably used as component A) in the coating compositions according to the invention. Such resin dispersions can be, on the one hand, so-called secondary dispersions, in which the resin preparation takes place first in an organic medium, generally a solvent, and the resin, after neutralisation, is dispersed in water in a second step. The solvent used for the preparation can either be removed by distillation following the dispersion or it can remain in the dispersion as cosolvent. On the other hand, so-called primary dispersions can also be used as resin dispersions. These are generally understood as being emulsion copolymers which are prepared directly in water with the aid of emulsifiers. Secondary dispersions are preferably used.

The resin dispersions A) used in the coating compositions according to the invention can be prepared both using external emulsifiers and with the aid of internal emulsifier functions. Internal emulsifiers are understood as being ionic groupings incorporated chemically into the resins, such as, for example, carboxylate or sulfonate groups, the corresponding counter-ions being, for example, alkaline, alkaline earth or ammonium ions or quaternary nitrogen atoms.

The resin dispersions A) used in the coating compositions according to the invention are generally hydroxy- or amino-functional. In exceptional cases it is additionally also possible to use non-functional dispersions as binder component A).

Preference is given to the use of hydroxy-functional resin dispersions which, based on solid resin, have a content of hydroxyl groups of from 0.5 to 7.0 wt. %, preferably from 0.5 to 6.0 wt. %, particularly preferably from 1.0 to 5.0 wt. %, and acid numbers of less than 50 mg KOH/g, preferably less than 40 mg KOH/g, particularly preferably less than 30 mg KOH/g.

The crosslinker component B) is any desired polyisocyanates modified by nanoparticles.

Suitable polyisocyanates B) are, for example, nanoparticle-modified polyisocyanate mixtures based on aliphatic, cycloaliphatic, araliphatic and/or aromatic diisocyanates having a mean NCO functionality of at least 2.1 and a content of isocyanate groups (calculated as NCO; molecular weight=42) of from 2.0 to 24.0 wt. %, which are prepared by reaction of
a1) a hydrophobic polyisocyanate component and/or
a2) a hydrophilically modified polyisocyanate component with
b) alkoxysilanes of formula (I)

Q-Z—SiXₙY₃₋ₙ (I)
in which
Q is a group reactive towards isocyanates,
X is a hydrolysable group,
Y is identical or different alkyl groups,
Z is a C₁-C₁₂-alkylene group and
n is an integer from 1 to 3,
   subsequent dispersion therein of
c) preferably surface-modified inorganic particles having a mean particle size, determined by means of dynamic light scattering in particle number weighting, of less than 200 nm
   and optionally addition of
d) solvents.

Suitable hydrophobic starting polyisocyanates a1) for the preparation of the curing agent component B) are any desired hydrophobic polyisocyanates having aliphatically, cycloaliphatically, araliphatically and/or aromatically bonded isocyanate groups, which have a (mean) NCO functionality of from 2.0 to 5.0, preferably from 2.3 to 4.5, a content of isocyanate groups of from 8.0 to 27.0 wt. %, preferably from 14.0 to 24.0 wt. %, and a content of monomeric diisocyanates of less than 1 wt. %, preferably less than 0.5 wt. %.

Such starting polyisocyanates are any desired polyisocyanates composed of at least two diisocyanates and having a uretdione, isocyanurate, allophanate, biuret, iminooxadiazinedione and/or oxadiazinetrione structure, prepared by modification of simple aliphatic, cycloaliphatic, araliphatic and/or aromatic diisocyanates, as are described by way of example in, for example, J. Prakt. Chem. 336 (1994) 185-200, DE-A 16 70 666, 19 54 093, 24 14 413, 24 52 532, 26 41 380, 37 00 209, 39 00 053 and 39 28 503 or in EP-A 336 205, 339 396 and 798 299.

Suitable diisocyanates for the preparation of such hydrophobic polyisocyanates a1) are any desired diisocyanates having aliphatically, cycloaliphatically, araliphatically and/or aromatically bonded isocyanate groups, which can be prepared by any desired processes, for example by phosgenation or by a phosgene-free route, for example by urethane cleavage. Suitable starting diisocyanates are, for example, those of the molecular weight range from 140 to 400 g/mol, such as, for example, 1,4-diisocyanatobutane, 1,6-diisocyanatohexane (HDI), 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanato-cyclohexane, 1,4-diisocyanato-3,3,5-trimethylcyclohexane, 1,3-diisocyanato-2-methyl-cyclohexane, 1,3-diisocyanato-4-methylcyclohexane, 1-isocyanato-3,3,5-trimethyl-5-isocyanatomethyl-cyclohexane (isophorone diisocyanate; PDT), 1-isocyanato-1-methyl-4(3)-isocyanatomethylcyclohexane, 2,4′- and 4,4′-diisocyanatodicyclohexylmethane, 1,3- and 1,4-bis(isocyanatomethyl)cyclohexane, 4,4′-diisocyanato-3,3′-dimethyldicyclohexyl-methane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanato-adamantane, 1,3-dimethyl-5,7-diisocyanatoadamantane, 1,3- and 1,4-bis-(isocyanato-methyl)benzene, 1,3- and 1,4-bis(1-isocyanato-1-methylethyl)-benzene (TMXDI), bis(4-(1-isocyanato-1-methylethyl)phenyl)carbonate, 1,3- and 1,4-phenylene diisocyanate, 2,4- and 2,6-toluene diisocyanate as well as arbitrary mixtures of those isomers, 2,4′- and/or 4,4′-diphenylmethane diisocyanate and 1,5-naphthalene diisocyanate as well as arbitrary mixtures of such diisocyanates. Further diisocyanates which are likewise suitable are additionally to be found, for example, in Justus Liebigs Annalen der Chemie Volume 562 (1949) p. 75-136.

The hydrophobic starting components a1) are preferably polyisocyanates or polyisocyanate mixtures of the mentioned type having solely aliphatically and/or cycloaliphatically bonded isocyanate groups.

Most particularly preferred hydrophobic starting components a1) are polyisocyanates or polyisocyanate mixtures having an isocyanurate structure based on HDI, IPDI and/or 4,4′-diisocyanatodicyclohexylmethane.

Suitable hydrophilically modified polyisocyanates a2) for the preparation of the crosslinker component B) consist of at least one of the above-mentioned hydrophobic starting polyisocyanates a1) as well as at least one ionic and/or non-ionic emulsifier e).

Suitable emulsifiers e) for the preparation of hydrophilically modified starting polyisocyanates a2) are any desired surface-active substances which, owing to their molecular structure, are capable of stabilising polyisocyanates or polyisocyanate mixtures in aqueous emulsions over a prolonged period.

One type of non-ionic emulsifier e) is, for example, reaction products e1) of the mentioned hydrophobic polyisocyanate components a1) with hydrophilic polyether alcohols.

Suitable hydrophilic polyether alcohols are mono- or poly-hydric polyalkylene oxide polyether alcohols having, in the statistical mean, from 5 to 50 ethylene oxide units per molecule, as are obtainable in a manner known per se by alkoxylation of suitable starter molecules (see e.g. Ullmanns Encyclopädie der technischen Chemie, 4th Edition, Volume 19, Verlag Chemie, Weinheim p. 31-38). Such starter molecules can be, for example, any desired mono- or poly-hydric alcohols of the molecular weight range from 32 to 300, such as, for example, methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-methyl-3-hydroxymethyloxetan, benzyl alcohol, phenol, the isomeric cresols, octylphenols, nonylphenols and naphthols, furfuryl alcohol, tetrahydrofurfuryl alcohol, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol, 4,4′-(1-methylethylidene)-biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl)-isocyanurate.

Alkylene oxides suitable for the alkoxylation reaction are in particular ethylene oxide and propylene oxide, which can be used in the alkoxylation reaction in any desired sequence or in admixture. Suitable polyether alcohols are either pure polyethylene oxide polyether alcohols or mixed polyalkylene oxide polyethers whose alkylene oxide units consist of at least 70 mol %, preferably at least 80 mol %, ethylene oxide units.

Preferred polyalkylene oxide polyether alcohols are those which have been prepared using as starter molecules the above-mentioned monoalcohols of the molecular weight range from 32 to 150. Particularly preferred polyether alcohols are pure polyethylene glycol monomethyl ether alcohols which contain, in the statistical mean, from 5 to 50, most particularly preferably from 5 to 25, ethylene oxide units.

The preparation of such non-ionic emulsifiers e1) is known in principle and is described, for example, in EP-B 0 206 059 and EP-B 0 540 985.

The preparation can be carried out by reacting the hydrophobic polyisocyanate components a1) with the mentioned polyether alcohols either in a separate reaction step with subsequent mixing with the polyisocyanate components a1) to be converted into a hydrophilic form, or in such a manner that the polyisocyanate components a1) are mixed with an appropriate amount of the polyether alcohols, there spontaneously being formed a hydrophilic polyisocyanate mixture according to the invention which contains, in addition to unreacted polyisocyanate a1), the emulsifier e1) which forms in situ from the polyether alcohol and a portion of component a1).

The preparation of this type of non-ionic emulsifiers e1) is generally carried out at temperatures of from 40 to 180° C., preferably from 50 to 150° C., while maintaining an NCO/OH equivalent ratio of from 2:1 to 400:1, preferably from 4:1 to 140:1.

In the first-mentioned variant, in which the non-ionic emulsifiers e1) are prepared separately, they are preferably prepared while maintaining an NCO/OH equivalent ratio of from 2:1 to 6:1. In the case of the in situ preparation of the emulsifiers e1), a higher excess of isocyanate groups within the above-mentioned broad range can, of course, be used.

The reaction of the hydrophobic polyisocyanate component a1) with the mentioned hydrophilic polyether alcohols to give non-ionic emulsifiers e1) can also be carried out, according to the process described in EP-B 0 959 087, in such a manner that at least a portion, preferably at least 60 mol %, of the urethane groups formed as primary product by NCO/OH reaction is reacted further to allophanate groups. In that case, the reactants are reacted in the above-mentioned NCO/OH equivalent ratio at temperatures of from 40 to 180° C., preferably from 50 to 150° C., generally in the presence of the catalysts suitable for accelerating the allophanatisation reaction that are mentioned in the cited patent specifications.

A further type of suitable non-ionic emulsifiers e) are, for example, reaction products of monomeric diisocyanates or diisocyanate mixtures with the above-mentioned mono- or poly-hydric hydrophilic polyether alcohols, in particular with pure polyethylene glycol monomethyl ether alcohols, which contain, in the statistical mean, from 5 to 50, preferably from 5 to 25, ethylene oxide units. The preparation of such emulsifiers e2) is likewise known and is described, for example, in EP-B 0 486 881.

However, the polyether urethane emulsifiers e2) can optionally also be reacted with the polyisocyanates A1) following the mixing of the components in the above-described relative proportions in the presence of suitable catalysts with allophanatisation. There likewise form hydrophilic polyisocyanate mixtures according to the invention which contain, in addition to unreacted polyisocyanate a1), a further non-ionic emulsifier type e3) having an allophanate structure which is formed in situ from the emulsifier e2) and a portion of component a1). The in situ preparation of such emulsifiers e3) is also already known and is described, for example, in WO 2005/047357.

Instead of the non-ionic emulsifiers e1) to e3) described by way of example, the hydrophilic polyisocyanate mixtures a2) can also contain emulsifiers containing ionic, in particular anionic, groups.

Such ionic emulsifiers e) are sulfonate-group-containing emulsifiers e4), as are obtainable, for example, by the process of WO 01/88006 by reaction of the hydrophobic polyisocyanate components a1) with 2-(cyclohexylamino)-ethanesulfonic acid and/or 3-(cyclohexylamino)-propanesulfonic acid. This reaction generally takes place at temperatures of from 40 to 150° C., preferably from 50 to 130° C., while maintaining an equivalent ratio of NCO groups to amino groups of from 2:1 to 400:1, preferably from 4:1 to 250:1, tertiary amines being used concomitantly to neutralise the sulfonic acid groups. Suitable neutralising amines are, for example, tertiary monoamines, such as, for example, trimethylamine, triethylamine, tripropylamine, tributylamine, dimethylcyclohexylamine, diisopropylethylamine, N-methylmorpholine, N-ethylmorpholine, N-methylpiperidine or N-ethylpiperidine, tertiary diamines, such as, for example, 1,3-bis-(dimethylamino)-propane, 1,4-bis-(dimethylamino)-butane or N,N′-dimethylpiperazine, or, although less preferred, alkanolamines, such as, for example, dimethylethanolamine, methyldiethanolamine or triethanolamine.

As already described for the non-ionic emulsifiers e1), the preparation of the ionic emulsifiers e4) can also be carried out either in a separate reaction step, with subsequent mixing with the hydrophobic polyisocyanate components a1) to be converted into a hydrophilic form, or in situ in those polyisocyanate components, whereby there is formed directly a hydrophilic polyisocyanate mixture according to the invention which contains, in addition to unreacted polyisocyanate a1), the emulsifier e4) which forms in situ from the aminosulfonic acids, the neutralising amine and a portion of the components a1).

A further type of suitable emulsifiers e) are those which contain ionic and non-ionic structures simultaneously in a molecule. These emulsifiers e5) are, for example, alkylphenol polyglycol ether phosphates and phosphonates or fatty alcohol polyglycol ether phosphates and phosphonates neutralised with tertiary amines, such as, for example, the above-mentioned neutralising amines, as are described, for example, in WO 97/31960 for the hydrophilisation of polyisocyanates, or alkylphenol polyglycol ether sulfates or fatty alcohol polyglycol ether sulfates neutralised with such tertiary amines.

Regardless of the nature of the emulsifier e) and its preparation, the amount thereof, or the amount of ionic and/or non-ionic components added to the hydrophobic polyisocyanates a1) in the case of an in situ preparation of the emulsifier, is generally such that the hydrophilically modified polyisocyanate mixtures a2) that are ultimately obtained contain an amount that ensures the dispersibility of the polyisocyanate mixture in water, preferably from 1 to 50 wt. %, particularly preferably from 2 to 30 wt. %, based on the total amount of components a1) and e.

The reaction of the hydrophobic starting polyisocyanates a1) with the ionic or non-ionic emulsifiers e) can be carried out without a solvent or optionally in a suitable solvent that is inert towards isocyanate groups. Suitable solvents are, for example, the conventional lacquer solvents known per se, such as, for example, ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, white spirit, higher substituted aromatic compounds, as are available commercially, for example, under the names solvent naphtha, Solvesso®, Isopar®, Nappar® (Deutsche EXXON CHEMICAL GmbH, Cologne, DE) and Shellsol® (Deutsche Shell Chemie GmbH, Eschborn, DE), carbonic acid esters, such as dimethyl carbonate, diethyl carbonate, 1,2-ethylene carbonate and 1,2-propylene carbonate, lactones, such as β-propiolactone, γ-butyrolactone, s-caprolactone and ε-methylcaprolactone, but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or arbitrary mixtures of such solvents.

In order to accelerate the reaction, however, conventional catalysts known from polyurethane chemistry can optionally also be used concomitantly in the preparation of the hydrophilically modified polyisocyanates a2), for example tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine or metal salts such as iron(III) chloride, aluminium tri(ethylacetoacetate), zinc chloride, zinc(II) n-octanoate, zinc(II) 2-ethyl-1-hexanoate, zinc(II) 2-ethylcaproate, zinc(II) stearate, zinc(II) naphthenate, zinc(II) acetylacetonate, tin(II) n-octanoate, tin(II) 2-ethyl-1-hexanoate, tin(II) ethylcaproate, tin(II) laurate, tin(II) palmitate, dibutyltin(IV) oxide, dibutyltin(IV) dichloride, dibutyltin(IV) diacetate, dibutyltin(IV) dimaleate, dibutyltin(IV) dilaurate, dioctyltin(IV) diacetate, zirconium (IV) 2-ethyl-1-hexanoate, zirconium(IV) neodecanoate, zirconium(IV) naphthenate, zirconium(IV) acetylacetonate, bismuth 2-ethyl-1-hexanoate, bismuth octoate, molybdenum glycolate, or arbitrary mixtures of such catalysts.

Preferred starting polyisocyanates a2) for the preparation of the curing agent component B) are polyisocyanates or polyisocyanate mixtures of the mentioned type having solely aliphatically and/or cycloaliphatically bonded isocyanate groups, which contain at least one of the above-described emulsifiers e1) to e5) or arbitrary mixtures of such emulsifiers. Most particularly preferred hydrophilic polyisocyanates a2) are those having an isocyanurate structure based on HDI, IPDI and/or 4,4′-diisocyanatodicyclohexylmethane.

Preferred starting polyisocyanates a) used in the curing agent component are hydrophobic polyisocyanates a1), and hydrophilic polyisocyanates a2) containing sulfonate-group-containing emulsifiers e4). Particularly preferred starting polyisocyanates a) used in the curing agent component are hydrophobic polyisocyanates a1).

Preferably, the group X in formula (I) is an alkoxy or hydroxy group, particularly preferably methoxy, ethoxy, propoxy or butoxy.

Preferably, Y in formula (I) represents a linear or branched C₁-C₄-alkyl group, preferably methyl or ethyl.

Z in formula (I) is preferably a linear or branched C₁-C₄-alkylene group.

Preferably, a in formula (I) represents 1 or 2.

Preferably, the group Q in formula (I) is a group that reacts with respect to isocyanates to form urethane, urea or thiourea. Such groups are preferably OH, SH or primary or secondary amino groups.

Preferred amino groups correspond to the formula —NHR¹, wherein R¹ is hydrogen, a C₁-C₁₂-alkyl group or a C₆-C₂₀-aryl group, or an aspartic acid ester radical of the formula R²OOC—CH₂—CH(COOR³)— wherein R², R³ are preferably identical or different alkyl radicals, which can optionally also be branched, having from 1 to 22 carbon atoms, preferably from 1 to 4 carbon atoms. Particularly preferably, R², R³ are each methyl or ethyl radicals.

Such alkoxysilane-functional aspartic acid esters are obtainable, as described in U.S. Pat. No. 5,364,955, in a manner known per se by addition of amino-functional alkoxysilanes to maleic or fumaric acid esters.

Amino-functional alkoxysilanes as can be used as compounds of formula (I) or in the preparation of the alkoxysilyl-functional aspartic acid esters are, for example, 2-aminoethyldimethylmethoxysilane, 3-aminopropyltrimethoxysilane, 3-aminopropyl-triethoxysilane, 3-aminopropylmethyldimethoxysilane, aminopropylmethyldiethoxysilane.

There can also be used as aminoalkoxysilanes having secondary amino groups of formula (I) in B) N-methyl-3-aminopropyltrimethoxysilane, N-methyl-3-amino-propyltriethoxysilane, N-phenyl-3-aminopropyltrimethoxysilane, bis-(gamma-trimethoxysilylpropyl)amine, N-butyl-3-aminopropyltrimethoxysilane, N-butyl-3-aminopropyltriethoxysilane, N-ethyl-3-aminoisobutyltrimethoxysilane, N-ethyl-3-aminoisobutyltriethoxysilane or N-ethyl-3-aminoisobutylmethyldimethoxysilane, N-ethyl-3-aminoisobutylmethyldiethoxysilane.

Suitable maleic or fumaric acid esters for the preparation of the aspartic acid esters are maleic acid dimethyl ester, maleic acid diethyl ester, maleic acid di-n-butyl ester as well as the corresponding fumaric esters. Maleic acid dimethyl ester and maleic acid diethyl ester are particularly preferred.

The preferred aminosilane for the preparation of the aspartic acid esters is 3-aminopropyltrimethoxysilane or 3-aminopropyltriethoxysilane.

The reaction of the maleic or fumaric acid esters with the aminoalkylalkoxysilanes is carried out within a temperature range of from 0 to 100° C., the relative proportions generally being so chosen that the starting compounds are used in a molar ratio of 1:1. The reaction can be carried out without a solvent or in the presence of solvents such as, for example, dioxane. The concomitant use of solvents is less preferred, however. Mixtures of different 3-aminoalkylalkoxysilanes can, of course, also be reacted with mixtures of fumaric and/or maleic acid esters.

Preferred alkoxysilanes for the modification of the polyisocyanates are secondary aminosilanes of the above-described type, particularly preferably aspartic acid esters of the above-described type as well as di- and mono-alkoxysilanes.

The above-mentioned alkoxysilanes can be used for the modification individually but also in mixtures.

It is important that the preparation of the nanoparticle-modified polyisocyanates is carried out without water, that is to say that no water is added separately, for example as a component in the process or as a solvent or dispersing agent. Preferably, therefore, the content of water in the process according to the invention is preferably less than 0.5 wt. %, particularly preferably less than 0.1 wt. %, based on the total amount of components a) to e) used.

In the modification, the ratio of free NCO groups of the isocyanate to be modified to the NCO-reactive groups Q of the alkoxysilane of formula (I) is preferably from 1:0.01 to 1:0.75, particularly preferably from 1:0.02 to 1:0.4, most particularly preferably from 1:0.04 to 1:0.2.

Of course, it is also possible in principle to modify higher proportions of NCO groups with the above-mentioned alkoxysilanes, but it must be ensured that the number of free NCO groups available for crosslinking is still sufficient for satisfactory crosslinking.

The reaction of aminosilane and polyisocyanate takes place at from 0 to 100° C., preferably from 0 to 50° C., particularly preferably from 15 to 40° C. Where appropriate, an exothermic reaction can be controlled by cooling.

The preparation of the curing agent component B) can optionally be carried out in a suitable solvent that is inert towards isocyanate groups. Suitable solvents are, for example, the lacquer solvents known per se that have already been mentioned above in the preparation of the hydrophilic polyisocyanate components a2), or arbitrary mixtures of such solvents.

During or following the modification of the polyisocyanate a) with silane b), the optionally surface-modified nanoparticles c) are introduced. This can be carried out simply by stirring in the particles. However, the use of increased dispersing energy is also conceivable, as can be effected, for example, by ultrasound, jet dispersion or high-speed stirrers by the rotor-stator principle. Simple mechanical stirring is preferred.

The particles can in principle be used both in powder form and in the form of suspensions or dispersions in suitable solvents that are preferably inert towards isocyanates. Preference is given to the use of the particles in the form of dispersions in organic solvents, the solvents preferably being inert towards isocyanates.

Solvents suitable for the organosols are methanol, ethanol, isopropanol, acetone, 2-butanone, methyl isobutyl ketone, as well as the solvents conventional per se in polyurethane chemistry, such as butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethyl sulfoxide, methyl ethyl ketone, or arbitrary mixtures of such solvents.

Preferred solvents are the solvents conventional per se in polyurethane chemistry, such as butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethyl sulfoxide, methyl ethyl ketone, or arbitrary mixtures of such solvents.

Particularly preferred solvents are solvents such as butyl acetate, 1-methoxy-2-propyl acetate, ethyl acetate, toluene, xylene, solvent naphtha (hydrocarbon mixture) as well as mixtures thereof. Ketone solvents such as methyl ethyl ketone are suitable as process solvents but not as solvents for the finished product.

In relation to the content of NCO groups later available for crosslinking, it has been found to be advantageous not to use alcohols either as solvents for the particle dispersions or as process solvents during the polyisocyanate modification because a comparatively higher degradation of NCO groups is here to be observed during storage of the nanoparticle-modified polyisocyanates prepared therefrom. If the polyisocyanates are blocked in an additional step, alcohols can also be used as solvents.

In a preferred embodiment of the invention there are used as particles in c) inorganic oxides, mixed oxides, hydroxides, sulfates, carbonates, carbides, borides and nitrides of elements of main groups II to IV and/or elements of subgroups I to VIII of the periodic system, including the lanthanides. Particularly preferred particles of component C) are silicon oxide, aluminium oxide, cerium oxide, zirconium oxide, niobium oxide and titanium oxide. Silicon oxide nanoparticles are most particularly preferred.

The particles used in c) preferably have mean particle sizes, determined by means of dynamic light scattering in dispersion, as the Z average, of from 5 to 100 nm, particularly preferably from 5 to 50 nm.

Preferably at least 75%, particularly preferably at least 90%, most particularly preferably at least 95% of all the particles used in c) have the sizes defined above.

Preferably, the particles are used in surface-modified form. If the particles used in c) are to be surface-modified, they are reacted, for example, with silanisation prior to being incorporated into the modified polyisocyanate. This method is known in the literature and is described, for example, in DE-A 19846660 or WO 03/44099.

The surfaces can further be modified adsorptively/associatively by means of surfactants having headgroups of corresponding interactions with the particle surfaces or block copolymers, as described, for example, in WO 2006/008120 and Foerster, S. & Antonietti, M., Advanced Materials, 10, no. 3, (1998) 195.

Preferred surface modification is silanisation with alkoxysilanes and/or chlorosilanes. Most particular preference is given to silanes that carry inert alkyl or aralkyl radicals in addition to the alkoxy groups but do not carry further functional groups.

Examples of commercial particle dispersions as are suitable for c) are Organosilicasol™ (Nissan Chemical America Corporation, USA), Nanobyk® 3650 (BYK Chemie, Wesel, Germany), Hanse XP21/1264 or Hanse XP21/1184 (Hanse Chemie, Hamburg, Germany), HIGHLINK® NanO G (Clariant GmbH, Sulzbach, Germany). Suitable organosols have a solids content of from 10 to 60 wt. %, preferably from 15 to 50 wt. %.

The content of particles used in c) (calculated as solid), based on the total system of modified polyisocyanate and particles, is typically from 1 to 70 wt. %, preferably from 5 to 60 wt. %, particularly preferably from 5 to 40 wt. %, most particularly preferably from 5 to 20 wt. %.

The solids content of nanoparticle-containing PICs according to the invention is from 20 to 100 wt. %, preferably from 60 to 100 wt. %, particularly preferably from 80 to 100 wt. %. A most particularly preferred form yields from 90 to 100%.

If solids contents of 100% are desired for solvent-free polyisocyanates, then the content of particles used in c) (calculated as solid), based on the total system of modified polyisocyanate and particles, is <30 wt. %, preferably <20 wt. %, most particularly preferably <12 wt. %.

The nanoparticle-modified, hydrophilic polyisocyanate mixtures B) according to the invention are transparent products of the above-mentioned composition, which can optionally also be in dissolved form in solvents, such as, for example, the conventional lacquer solvents mentioned above.

Nanoparticle-modified polyisocyanate mixtures B) can optionally also consist of mixtures of hydrophilic and hydrophobic polyisocyanates, or nanoparticle-modified hydrophilic polyisocyanates can be combined with hydrophobic polyisocyanates or nanoparticle-modified hydrophobic polyisocyanates can be combined with hydrophilic polyisocyanates. In such mixtures, the hydrophilised polyisocyanates act as an emulsifier for the proportion of non-hydrophilic polyisocyanates added subsequently.

The curing agent component B) used in the coating compositions according to the invention, which is optionally in solution in an inert solvent, generally has a viscosity at 23° C. of from 50 to 10,000 mPas, preferably from 50 to 2000 mPas (D=40). The maximum amount of solvent in the curing agent component is such that, in the aqueous coating compositions according to the invention that are ultimately obtained, not more than 50 wt. %, preferably not more than 30 wt. %, particularly preferably not more than 10 wt. %, based on the solids content, of organic solvents is present, the solvent optionally already contained in the resin dispersions A) also being included in the calculation. Suitable solvents are, for example, conventional lacquer solvents, as have already been described above by way of example in the preparation of the curing agent component B).

For the preparation of the aqueous coating compositions, the curing agent component B) is emulsified in the aqueous resin component A). The resin dispersion A) and the curing agent component B) are thereby combined with one another in amounts such that from 0.5 to 2, preferably from 0.6 to 1.8 and particularly preferably from 0.7 to 1.5 isocyanate groups of component B) are present for each hydroxyl or amino group of component A). When non-functional resin dispersions, that is to say resin dispersions which do not carry any isocyanate-reactive groups, are used, the curing agent component is generally used in amounts of up to 20 wt. %, preferably up to 10 wt. %, based on the total amount of resin dispersion A) and curing agent component B).

Preferably from 30 to 80 wt. % of the aqueous, hydroxy- and/or amino-functional resin dispersion A) are used, particularly preferably from 40 to 70 wt. %, based on components A) and B).

Preferably from 20 to 80 wt. % of the nanoparticle-modified polyisocyanate B) are used, particularly preferably from 20 to 60 wt. %, most particularly preferably from 30 to 55 wt. %, based on components A) and B).

To the mixture of A) and B), but preferably before the addition of component B), there can be incorporated into component A) or B), but particularly preferably A), the auxiliary substances and additives C) as well as pigments D) and lacquer solvents E) conventional in lacquer technology. The desired processing viscosity is adjusted by addition of water.

There can be used as auxiliary substances and additives C), for example, antifoams, emulsifiers, dispersing aids, thickeners, curing catalysts, colourings, mattifying agents, flameproofing agents, hydrolytic stabilisers, microbicides, algicides, flow agents, antioxidants, light stabilisers, water capturers, thixotropic carriers, wetting agents, deaerating agents and also adhesion promoters. These auxiliary substances and additives C) are mixed into component A) and/or B) according to the requirements of the problems to be solved by application of the coating and their compatibility. For example, water-containing additives or additives having a strongly alkaline reaction should be mixed not with the polyisocyanate component B) but with the binder A).

Suitable curing catalysts for the coating compositions according to the invention are, for example, the compounds known from polyurethane chemistry for accelerating isocyanate reactions, such as, for example, the known tin or bismuth compounds and tertiary amines, as are described in greater detail, for example, in “Kunststoff Handbuch 7, Polyurethane” Carl-Hanser-Verlag, Munich-Vienna, 1984, p. 97-98. Preference is given to tin or bismuth compounds. Such catalysts, if used at all, can be employed in amounts of up to 2 wt. %, based on the weight of the binder consisting of the individual components A), optionally B) and C).

Silanes can be used as adhesion promoters. A preferred adhesion promoter is glycidoxypropyltrimethoxysilane.

Mattifying agents, flameproofing agents, hydrolytic stabilisers, microbicides, algicides, flow agents, antioxidants, light stabilisers, water capturers, thixotropic carriers, wetting agents or deaerating agents which are optionally also to be used concomitantly as auxiliary substances and additives C) in the coating compositions according to the invention are described, for example, in “Lehrbuch der Lacke und Beschichtungen, Band III., Lösemittel, Weichmacher, Additive, Zwischenprodukte”, H. Kittel, Verlag W. A. Colomb in der Heenemann GmbH, Berlin-Oberschwandorf, 1976, p. 237-398. Drying agents acting as water capturers are described in greater detail, for example, in “Kunststoff Handbuch 7, Polyurethane”, Carl-Hanser-Verlag, Munich-Vienna, 1983, p. 545. Such auxiliary substances and additives that are preferably used are flow agents, thickeners/thixotropic carriers, deaerating agents and adhesion promoters.

The total amount of such auxiliary substances and additives C) is preferably up to 30 wt. %, particularly preferably up to 20 wt. %, based on the binder consisting of the individual components A), optionally B) and C).

Suitable fillers are, for example, stone or plastics granules, glass spheres, sand, cork, chalk or talcum. Preferred fillers are chalk or talcum. Suitable pigments are, for example, titanium dioxide, zinc oxide, iron oxides, chromium oxides or carbon blacks. A detailed overview of pigments for paints is given in “Lehrbuch der Lacke und Beschichtungen, Band II, Pigmente, Füllstoffe, Farbstoffe”, Kittel, Verlag W. A. Colomb in der Heenemann GmbH, Berlin-Oberschwandorf, 1974, p. 17-265. Titanium dioxide is preferably used as the pigment. The fillers and pigments mentioned by way of example, if they are used at all, can be employed in amounts of up to 95 wt. %, preferably up to 80 wt. %, based on the binder mixture consisting of individual components A), optionally B) and C).

Suitable solvents E) are, for example, the above-mentioned particularly suitable conventional inert lacquer solvents optionally used in the preparation of the polyisocyanate component B). There are preferably used as lacquer solvents methoxypropyl acetate, 3-methoxy-1-butyl acetate, propylene n-butyl ether, dibasic ester and solvent naphtha, particularly preferably methoxypropyl acetate, 3-methoxy-1-butyl acetate, propylene n-butyl ether, dibasic ester. Such lacquer solvents, if used at all, are employed in the coating compositions according to the invention in an amount of up to 50%, preferably up to 30%, particularly preferably up to 20%, based on the total amount of components A) to C).

Components A) to E) used in the coating compositions according to the invention can be incorporated by conventional dispersing techniques, such as, for example, manually or by rotor-stator systems, ultrasonic techniques, bead mills or jet dispersing apparatuses.

In the case of hydrophilic polyisocyanates as curing agent component B), simple emulsifying techniques, for example with a mechanical stirrer, or often also simple mixing of the two components by hand are sufficient to achieve coatings having very good properties. However, it is of course also possible to use other mixing techniques with higher shear energy, such as, for example, jet dispersion (Farbe & Lack 102/3, 1996, p. 88-100).

The coating compositions according to the invention so obtained are suitable for all fields of use in which coatings having an enhanced property profile are used, such as, for example, in the coating of mineral building materials, road coverings, wood and derived timber products, metal surfaces, plastics, glass or paper, in addition in the bonding of various materials. They can be used in particular as primers, fillers, pigmented covering lacquers and clear lacquers in the field of automotive repair lacquering or large vehicle lacquering. The coating compositions are particularly suitable for applications in which improved corrosion protection is required.

The coating compositions according to the invention can be applied by a wide variety of spraying processes, such as, for example, compressed air, airless or electrostatic spraying processes using one- or two-component spraying systems, but also by spread coating, roller coating or doctor blade application.

Drying and curing of the coatings generally takes place under normal temperature conditions, that is to say without heating the coating. However, the binder combinations according to the invention can also be used to produce coatings which, after application, are dried and cured at elevated temperature, for example at from 40 to 250° C., preferably from 40 to 150° C. and in particular from 40 to 100° C.

Coating compositions according to the invention containing nano-modified curing agent components B) are distinguished by very good corrosion protection and UV resistance as well as higher hardness and optionally better substrate adhesion as compared with conventional coatings.

### EXAMPLES

Unless indicated otherwise, percentages are to be understood as being percent by weight.

The hydroxyl number (OH number) was determined according to DIN 53240-2.

The viscosity was determined by means of a “RotoVisco 1” rotary viscometer from Haake, Germany according to DIN EN ISO 3219/A.3.

The acid number was determined according to DIN EN ISO 2114.

The colour index (APHA) was determined according to DIN EN 1557.

The NCO content was determined according to DIN EN ISO 11909.

The residual monomer content was determined according to DIN EN ISO 10 283.

Butoxyl: abbreviation for 3-methoxy-n-butyl acetate

Organosilicasol™ MEK-ST: colloidal silica dispersed in methyl ethyl ketone, particle size 10-15 nm, 30 wt. % SiO₂, <0.5 wt. % H₂O, <5 mPa s viscosity, Nissan Chemical America Corporation, USA

Dynasylan® 1189: N-(n-butyl)-3-aminopropyltrimethoxysilane, Degussa/Evonik AG, Germany

Surfynol® 104 BC: non-ionic surface-active surfactant, AirProducts, Germany

Borchigel® PW 25: thickener, OMG Borchers GmbH, Germany

Baysilone® LA 200: antifoam/deaerating agent, OMG Borchers GmbH, Germany

Baysilone® 3468: wetting agent, OMG Borchers GmbH, Germany

Borchigen® SN 95: wetting and dispersing additive, OMG Borchers GmbH, Germany

Tronox® R-KB-4: titanium dioxide pigment, Tronox Inc., Germany

Tinuvin® 292, 1130: light stabilisers, Ciba AG, Switzerland

Dynasylan® GLYMO: 3-glycidyloxypropyltrimethoxysilane, Degussa/Evonik AG, Germany

Bayhydrol® XP 2470: water-dilutable, OH-functional polyacrylate dispersion, delivery form approximately 45% in water/Solvent Naphtha® 100/Dowanol® PnB, neutralised with dimethylethanolamine/triethanolamine, viscosity at 23° C. 2000±500 mPa·s, OH content approximately 3.9%, acid number approximately 10 mg KOH/g (Bayer MaterialScience AG/Leverkusen, Germany)

Bayhydrol® XP 2645: water-dilutable, OH-functional polyacrylate dispersion, delivery form approximately 43% in water/Solvent Naphtha 100/Dowanol® PnB, neutralised with dimethylethanolamine, viscosity at 23° C. 500-4000 mPa·s, OH content approximately 4.5%, acid number approximately 9 mg KOH/g (Bayer MaterialScience AG/Leverkusen, Germany)

Bayhydrol® XP 2695: water-dilutable, OH-functional polyacrylate dispersion, delivery form approximately 41% in water/1-butoxy-2-propanol, neutralised with triethanolamine/dimethylethanolamine (3:1), viscosity at 23° C. approximately 2500 mPa·s, OH content approximately 5.0%, acid number approximately 9.4 mg KOH/g (Bayer MaterialScience AG/Leverkusen, Germany)

### Determination of the Particle Size

The particle sizes were determined by means of dynamic light scattering using an HPPS particle size analyzer (Malvern, Worcestershire, UK). Evaluation was made using Dispersion Technology Software 4.10. In order to avoid multiple scattering, a highly dilute dispersion of the nanoparticles was prepared. A drop of a dilute nanoparticle dispersion (approximately 0.1-10%) was placed in a cuvette containing approximately 2 ml of the same solvent as the dispersion, shaken and measured in the HPPS analyzer at 20 to 25° C. As generally known to the person skilled in the art, the relevant parameters of the dispersing medium—temperature, viscosity and refractive index—were entered into the software beforehand. In the case of organic solvents, a glass cuvette was used. An intensity or volume/particle diameter curve as well as the Z average for the particle diameter was obtained as the result. It was ensured that the polydispersity index was <0.5.

Pendulum damping (König) according to DIN EN ISO 1522 “Pendulum damping test”

Scratch resistance laboratory car-wash (wet scratching) according to DIN EN ISO 20566 “Paints and varnishes—Determination of the scratch resistance of a coating system using a laboratory car-wash”

Gloss/haze measurement according to DIN EN ISO 13803 “Determination of the reflection haze of coatings at 20°” and DIN EN ISO 2813 “Determination of the reflectometer value of coatings”

### Determination of Solvent Resistance

By means of this test, the resistance of a cured lacquer film to various solvents was determined. To that end, the solvents are allowed to act on the lacquer surface for a specific time. Then an assessment is made, visually and by touch, of whether and what changes have occurred on the test surface. The lacquer film is generally on a glass sheet, although other substrates are also possible. The test tube stand containing the solvents xylene, 1-methoxy-2-propyl acetate, ethyl acetate and acetone (see below) is placed on the lacquer surface so that the openings of the test tubes with the cotton wool plugs lie on the film. It is important that the lacquer surface is thereby wetted with the solvent. After the specified exposure time to the solvents of 1 minute and 5 minutes, the test tube stand is removed from the lacquer surface. The solvent residues are then immediately removed by means of absorbent paper or textile fabric. After careful scratching with a fingernail, the test surface is then immediately checked visually for changes. A distinction is made between the following stages:

0=unchanged
1=trace changed e.g. only visible change
2=slightly changed e.g. softening perceptible with the fingernail detectable
3=markedly changed e.g. pronounced softening detectable with the fingernail
4=considerably changed e.g. with the fingernail to the substrate
5=destroyed e.g. lacquer surface destroyed without external influence

The ratings found for the solvents indicated above are documented in the following sequence:
Example 0000 (no change)
Example 0001 (visible change only in the case of acetone)

The numerical sequence describes the sequence of the solvents tested (xylene, methoxypropyl acetate, ethyl acetate, acetone).

### Determination of Scratch Resistance by Means of the Hammer Test (Dry Scratching)

Scratching is carried out using a hammer (weight: 800 g without handle) to the flat side of which steel wool 00 is fastened. To that end, the hammer is carefully placed at a right angle on the coated surface and guided in a path over the coating without being tilted and without additional body weight. 10 to-and-fro strokes are carried out. After exposure to the scratching medium, the test surface is cleaned with a soft cloth and then the gloss is measured transversely to the direction of scratching according to DIN EN ISO 2813. Only homogeneous regions may be measured. Information regarding scratching is usually given as % retention or loss of gloss relative to the starting gloss.

Condensation water test according to DIN EN ISO 6270/2 CH “Paints and varnishes—Determination of resistance to humidity”

Salt spray test according to DIN EN ISO 9227 NSS: “Corrosion tests in artificial atmospheres—Salt spray tests”

Evaluation of damage in each case according to DIN EN ISO 4628 “Paints and varnishes—Evaluation of degradation of coatings—Designation of quantity and size of defects, and of intensity of uniform changes in appearance”

Weathering (CAM 180): UV accelerated weathering according to SAE J2527 CAM 180 “Performance Based Standard for Accelerated Exposure of Automotive Exterior Materials Using a Controlled Irradiance Xenon-Arc Apparatus”

Starting Polyisocyanate a2)-1 Containing Emulsifier Type e4):

A mixture of 400 g (2.07 val) of an isocyanurate-group-containing polyisocyanate based on 1,6-diisocyanatohexane (HDI) having an NCO content of 21.7%, a mean NCO functionality of 3.5 (according to GPC), a content of monomeric HDI of 0.1% and a viscosity of 3000 mPas (23° C.) and 600 g (3.36 val) of an HDI-based iminooxadiazinedione-group-containing polyisocyanate having an NCO content of 23.5%, a mean NCO functionality of 3.1 (according to GPC), a content of monomeric HDI of 0.2% and a viscosity of 700 mPas (23° C.) is stirred for 10 hours at 80° C., under dry nitrogen, together with 30 g (0.14 val) of 3-(cyclohexylamino)-propanesulfonic acid (CAPS) and 18 g (0.14 mol) of dimethylcyclohexylamine. After cooling to room temperature, a virtually colourless, clear polyisocyanate mixture having the following characteristic data is obtained:

Solids content: 100%
NCO content: 21.2%
NCO functionality: 3.2
Viscosity (23° C.): 3500 mPas
Colour index: 60 APHA
Starting Polyisocyanate A2)-2 Containing Emulsifier Type e1):

870 g (4.50 val) of the isocyanurate-group-containing, HDI-based polyisocyanate described in the preparation of starting polyisocyanate a2)-1 are placed in a reaction vessel at 100° C., under dry nitrogen and with stirring; in the course of 30 minutes, 130 g (0.37 val) of a methanol-started, monofunctional polyethylene oxide polyether having a mean molecular weight of 350 are added and stirring is continued at that temperature until the NCO content of the mixture has fallen after about 2 hours to a value of 17.4%. After cooling to room temperature, a colourless, clear polyisocyanate mixture having the following characteristic data is obtained:

Solids content: 100%
NCO content: 17.4%
NCO functionality: 3.2
Viscosity (23° C.): 2800 mPas
Colour index: 40 APHA
Starting Polyisocyanate a2)-3 Containing Emulsifier Type e3):

910 g (4.70 val) of the isocyanurate-group-containing, HDI-based polyisocyanate described in the preparation of starting polyisocyanate a2)-1 are placed in a reaction vessel at 100° C., under dry nitrogen and with stirring; in the course of 30 minutes, 90 g (0.18 val) of a methanol-started, monofunctional polyethylene oxide polyether having a mean molecular weight of 500 are added and then stirring is continued at that temperature until the NCO content of the mixture has fallen after about 2 hours to the value of 18.7%, corresponding to complete urethanisation. 0.01 g of zinc(II) 2-ethyl-1-hexanoate is then added as allophanatisation catalyst. The temperature of the reaction mixture thereby rises to 106° C. owing to the heat of reaction that is released. When the heat of reaction has subsided, about 30 minutes after addition of the catalyst, the reaction is terminated by addition of 0.01 g of benzoyl chloride and the reaction mixture is cooled to room temperature. A virtually colourless, clear polyisocyanate mixture having the following characteristic data is obtained:

Solids content: 100%
NCO content: 18.2%
NCO functionality: 3.5
Viscosity (23° C.): 4000 mPas
Colour index: 60 APHA
Starting Polyisocyanate a2)-4 Containing Emulsifier Type e3):

According to the process described for starting polyisocyanate a2)-3, 860 g (4.44 val) of the isocyanurate-group-containing, HDI polyisocyanate described therein and 140 g (0.28 val) of the polyethylene oxide polyether described therein are reacted in the presence of 0.01 g of zinc(II) 2-ethyl-1-hexanoate as allophanatisation catalyst to give a colourless, clear polyisocyanate mixture having the following characteristic data:

Solids content: 100%
NCO content: 16.2%
NCO functionality: 4.0
Viscosity (23° C.): 6500 mPas
Colour index: 60 APHA
Starting Polyisocyanate A2)-5 Containing Emulsifier Type e4):

According to the process described for starting polyisocyanate a2)-1, 980 g (5.06 val) of the isocyanurate-group-containing, HDI polyisocyanate described therein, 20 g (0.09 val) of CAPS, 11 g (0.09 mol) of dimethylcyclohexylamine are reacted to give a colourless, clear polyisocyanate mixture having the following characteristic data:

Solids content: 100%
NCO content: 20.6%
NCO functionality: 3.4
Viscosity (23° C.): 5400 mPas
Colour index: 40 APHA
Starting Polyisocyanate A2)-6 Containing Emulsifier Type e5):

890 g (4.60 val) of the isocyanurate-group-containing, HDI-based polyisocyanate described in the preparation of starting polyisocyanate a2)-1 are stirred for 12 hours at 80° C. with 110 g of an emulsifier mixture consisting of 97 g of an ethoxylated tridecyl alcohol phosphate (Rhodafac® RS-710, Rhodia) and 13 g of dimethylcyclohexylamine as neutralising amine. After cooling to room temperature, a colourless, clear polyisocyanate mixture having the following characteristic data is obtained:

Solids content: 100%
NCO content: 19.3%
NCO functionality: 3.5
Viscosity (23° C.): 3000 mPas
Colour index: 30 APHA
Starting Polyisocyanate a1)-1

Isocyanurate-group-containing polyisocyanate based on 1,6-diisocyanatohexane (HDI) having an NCO content of 23±0.5%, a content of monomeric HDI of ≦0.2%, a colour index<40 and a viscosity of 1200±300 mPas (23° C.).

Starting Polyisocyanate a1)-2

Iminooxadiazinedione-group-containing, HDI-based polyisocyanate having an NCO content of 23.5±0.5%, a content of monomeric HDI of <0.3%, a colour index<40 and a viscosity of 700±100 mPas (23° C.).

### Example 1

N-(3-Trimethoxysilylpropyl)aspartic acid diethyl ester was prepared, according to the teaching of US-A 5 364 955, Example 5, by reacting equimolar amounts of 3-aminopropyltrimethoxysilane and maleic acid diethyl ester.

### Example 2

1287.5 g of starting polyisocyanate a2)-1 in 700 g of methyl ethyl ketone were placed at room temperature in a standard stirring apparatus, and nitrogen was passed over at a rate of 2 litres/hour. Then, in the course of 2 hours, while stirring at room temperature, 112.5 g (0.05 val) of the alkoxysilane from Example 1 in 700 g of methyl ethyl ketone were added dropwise until the theoretical NCO content was reached. During the addition, the temperature was kept at a maximum of 40° C.

1279.5 g of the polyisocyanate so modified with alkoxysilane were mixed with 220.5 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 15.99%, viscosity 12,700 mPas (23° C.), particle size 54.2 nm, 10% SiO₂ content.

### Example 3

1106.6 g of starting polyisocyanate a2)-1 were placed at room temperature in a standard stirring apparatus, and nitrogen was passed over at a rate of 2 litres/hour. Then, in the course of 2 hours, at room temperature, 193.4 g (0.1 val) of the alkoxysilane from Example 1 were added dropwise until the theoretical NCO content was reached. During the addition, the temperature was kept at a maximum of 40° C.

1080 g of the polyisocyanate so modified with alkoxysilane were mixed with 378.5 g of Nissan Organosol MEK-ST and adjusted to a solids content of 100% in a rotary evaporator at 60° C. and 120 mbar.

A translucent, liquid polyisocyanate having the following characteristic data was obtained: solids content 100 wt. %, NCO content 13.3%, viscosity 24,900 mPas (23° C.), particle size 54.6 nm, 10% SiO₂ content.

### Example 4

466.1 g of starting polyisocyanate a2)-2 in 250 g of methyl ethyl ketone were placed at room temperature in a standard stirring apparatus, and nitrogen was passed over at a rate of 2 litres/hour. Then, in the course of 2 hours, while stirring at room temperature, 33.9 g (0.05 val) of the alkoxysilane from Example 1 in 250 g of methyl ethyl ketone were added dropwise until the theoretical NCO content was reached. During the addition, the temperature was kept at a maximum of 40° C.

508.4 g of the polyisocyanate so modified with alkoxysilane were mixed with 91.6 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 13.22%, viscosity 7400 mPas (23° C.), particle size 31.4 nm, 10% SiO₂ content.

### Example 5

465.0 g of starting polyisocyanate a2)-3 in 250 g of methyl ethyl ketone were placed at room temperature in a standard stirring apparatus, and nitrogen was passed over at a rate of 2 litres/hour. Then, in the course of 2 hours, while stirring at room temperature, 34.99 g (0.05 val) of the alkoxysilane from Example 1 in 250 g of methyl ethyl ketone were added dropwise until the theoretical NCO content was reached. During the addition, the temperature was kept at a maximum of 40° C.

937.2 g of the polyisocyanate so modified with alkoxysilane were mixed with 162.8 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 13.5%, viscosity 17,100 mPas (23° C.), particle size 46.7 nm, 10% SiO₂ content.

### Example 6

468.3 g of starting polyisocyanate a2)-4 in 250 g of methyl ethyl ketone were placed at room temperature in a standard stirring apparatus, and nitrogen was passed over at a rate of 2 litres/hour. Then, in the course of 2 hours, while stirring at room temperature, 31.7 g (0.05 val) of the alkoxysilane from Example 1 in 250 g of methyl ethyl ketone were added dropwise until the theoretical NCO content was reached. During the addition, the temperature was kept at a maximum of 40° C.

510 g of the polyisocyanate so modified with alkoxysilane were mixed with 90 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 12.55%, viscosity 16,300 mPas (23° C.), particle size 34.6 nm, 10% SiO₂ content.

### Example 7

472.7 g of starting polyisocyanate a2)-5 in 250 g of methyl ethyl ketone were placed at room temperature in a standard stirring apparatus, and nitrogen was passed over at a rate of 2 litres/hour. Then, in the course of 2 hours, while stirring at room temperature, 27.3 g (0.05 val) of Dynasilan 1189 in 250 g of methyl ethyl ketone were added dropwise until the theoretical NCO content was reached. During the addition, the temperature was kept at a maximum of 40° C.

935 g of the polyisocyanate so modified with alkoxysilane were mixed with 165 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 16.14%, viscosity 17,700 mPas (23° C.), particle size 68.9 nm, 10% SiO₂ content.

### Example 8

467.3 g of starting polyisocyanate a2)-6 in 350 g of butyl acetate were placed at room temperature in a standard stirring apparatus, and nitrogen was passed over at a rate of 2 litres/hour. Then, in the course of 2 hours, while stirring at room temperature, 32.7 g (0.05 val) of the alkoxysilane from Example 1 in 150 g of butyl acetate were added dropwise until the theoretical NCO content was reached. During the addition, the temperature was kept at a maximum of 40° C.

466.8 g of the polyisocyanate so modified with alkoxysilane were mixed with 79.6 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 13.16%, viscosity 7400 mPas (23° C.), particle size 21.4 nm, 10% SiO₂ content.

### Example 9

466.1 g of starting polyisocyanate a2)-2 in 250 g of methoxypropyl acetate were placed at room temperature in a standard stirring apparatus, and nitrogen was passed over at a rate of 2 litres/hour. Then, in the course of 2 hours, while stirring at room temperature, 33.9 g (0.05 val) of the alkoxysilane from Example 1 in 250 g of methoxypropyl acetate were added dropwise until the theoretical NCO content was reached. During the addition, the temperature was kept at a maximum of 40° C.

481.6 g of the polyisocyanate so modified with alkoxysilane were mixed with 268.4 g of Nissan Organosol A/MK-ST and adjusted to a solids content of 65% in a rotary evaporator at 60° C. and 120 mbar. Then 750 ml of methoxypropyl acetate were added and the solids content was again adjusted to 65% in a rotary evaporator at 60° C. and 120 mbar.

A transparent, liquid polyisocyanate having the following characteristic data was obtained: solids content 69.1 wt. %, NCO content 7.23%, viscosity 162 mPas (23° C.), particle size 29.2 nm, 26% SiO₂ content in the solid.

### Example 10

397.5 g of starting polyisocyanate a1)-1 in 250 g of butyl acetate were placed at room temperature in a standard stirring apparatus, and nitrogen was passed over at a rate of 2 litres/hour. Then, in the course of 2 hours, while stirring at room temperature, 102.5 g (0.2 val) of Dynasilan 1189 in 250 g of butyl acetate were added dropwise until the theoretical NCO content was reached. During the addition, the temperature was kept at a maximum of 40° C.

936 g of the polyisocyanate so modified with alkoxysilane were mixed with 164 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 12.3%, viscosity 8100 mPas (23° C.), particle size 32.8 nm, 10% SiO₂ content in the solid.

### Example 11

883.6 g of starting polyisocyanate a1)-2 in 500 g of methyl ethyl ketone were placed at room temperature in a standard stirring apparatus, and nitrogen was passed over at a rate of 2 litres/hour. Then, in the course of 2 hours, while stirring at room temperature, 116.4 g (0.1 val) of Dynasilan 1189 in 500 g of methyl ethyl ketone were added dropwise until the theoretical NCO content was reached. During the addition, the temperature was kept at a maximum of 40° C.

939.4 g of the polyisocyanate so modified with alkoxysilane were mixed with 160.6 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 15.9%, viscosity 3250 mPas (23° C.), particle size 40.2 nm, 10% SiO₂ content in the solid.

### Example 12

501.8 g of starting polyisocyanate a1)-1 in 275 g of methoxypropyl acetate were placed at room temperature in a standard stirring apparatus, and nitrogen was passed over at a rate of 2 litres/hour. Then, in the course of 2 hours, while stirring at room temperature, 48.3 g (0.05 val) of the alkoxysilane from Example 1 in 275 g of methoxypropyl acetate were added dropwise until the theoretical NCO content was reached. During the addition, the temperature was kept at a maximum of 40° C.

290.4 g of the polyisocyanate so modified with alkoxysilane were mixed with 459.6 g of Nissan Organosol MEK-ST and adjusted to a solids content of 80% in a rotary evaporator at 60° C. and 120 mbar. Then 750 ml of methoxypropyl acetate were added and the solids content was again adjusted to 80% in a rotary evaporator at 60° C. and 120 mbar.

A transparent, liquid polyisocyanate having the following characteristic data was obtained: solids content 62.5 wt. %, NCO content 5.54%, viscosity 730 mPas (23° C.), particle size 25.6 nm, 50% SiO₂ content in the solid.

### Example 14

### Lacquer Formulations Clear Lacquer

| | 1 | 2 | 3 | 4 | 5 | 6 |
|---|---|---|---|---|---|---|
| Polyol Bayhydrol type | XP 2645 | XP 2645 | XP 2470 | XP 2470 | XP 2695 | XP 2695 |
| Solids % | 43 | 43 | 45 | 45 | 41 | 41 |
| OH % | 4.5 | 4.5 | 3.9 | 3.9 | 5.00 | 5.00 |
| Polyisocyanate | a2)-5 | Ex. 7 | a2)-5 | Ex. 7 | a2)-5 | Ex. 7 |
| Solids % | 100 | 100 | 100 | 100 | 100 | 100 |
| NCO % | 20.6 | 16.14 | 20.6 | 16.14 | 20.6 | 16.14 |
| SiO2 content in the PIC % | 0 | 10 | 0 | 10 | 0 | 10 |
| NCO:OH | 1.5 | 1.5 | 1.5 | 1.5 | 1.5 | 1.5 |
| Component 1 | | | | | | |
| XP 2645 | 89.0 | 100.0 | | | | |
| XP 2470 | | | 101.6 | 91.2 | | |
| XP 2695 | | | | | 99.9 | 88.4 |
| Surfynol 104 BC (Del. | 2.3 | 2.3 | 2.3 | 2.3 | 2.3 | 2.3 |
| form 50%) | | | | | | |
| Borchigel PW 25 (Del. form | 0.3 | 0.3 | 0.3 | 0.3 | 0.3 | 0.3 |
| 25%) | | | | | | |
| Baysilone 3468 (10% in | 1.9 | 1.9 | 1.9 | 1.9 | 1.9 | 1.9 |
| solution in BG) | | | | | | |
| Tinuvin 292 | 0.8 | 0.8 | 0.8 | 0.8 | 0.8 | 0.8 |
| Tinuvin 1130 | 1.6 | 1.6 | 1.6 | 1.6 | 1.6 | 1.6 |
| demin. H20 to DIN 6 40 sec. | 10.1 | 10.0 | 10.0 | 8.1 | 10.8 | 9.3 |
| Total comp. 1 | 106.0 | 116.9 | 118.5 | 106.2 | 117.6 | 104.6 |
| Component 2 | | | | | | |
| Ex. 7 (80% in 3-methoxy-n- | | 55.5 | | 46.0 | | 52.0 |
| butyl acetate) | | | | | | |
| Ex. a2)-5 (80% in 3- | 38.7 | | 40.1 | | 46.1 | |
| methoxy-n-butyl acetate) | | | | | | |
| Total comp. 1 + 2 | 144.7 | 172.4 | 158.6 | 152.2 | 163.7 | 156.5 |
| demin. H2O to spraying | 33.0 | 45.4 | 33.5 | 30.3 | 37.3 | 35.9 |
| viscosity. | | | | | | |
| Spraying viscosity DIN 4 | 24.0 | 23.0 | 22.0 | 26.0 | 25.0 | 22.0 |
| (about 25 sec.) | | | | | | |
| Solids in % | 41.1 | 41.9 | 42.5 | 44.7 | 40.6 | 42.4 |
| Nano content in the solid | 0.0 | 4.9 | 0.0 | 4.5 | 0.0 | 5.1 |
| (%) | | | | | | |

### Comparison Examples 13.1, 13.3, 13.5

### Examples 13.2, 13.4, 13.6 According to the Invention

The polyol mixture was placed in a reaction vessel in each case; the additives and light stabiliser were added and the whole was mixed thoroughly, with stirring. It was then adjusted to a runout viscosity of 40 seconds (DIN 6 beaker) with demineralised water. After a stirring time of one day (for deaeration), the polyisocyanate/solvent mixture was added, and the mixture was stirred thoroughly again and adjusted to a spraying viscosity of 25 seconds (DIN 4 beaker) with demineralised water.

The lacquer was then applied to the prepared substrate using a Sata Digital RP 2 gravity spray gun (1.4 mm nozzle) in 1.5 cross-coats. After an aeration time of 30 minutes, the lacquer was dried at 60° C. for 30 minutes. The dry layer thickness was in each case approximately from 50 to 60 μm.

### Example 14

### Lacquer Testing Clear Lacquers from Example 13

| | 1 | 2 | 3 | 4 | 5 | 6 |
|---|---|---|---|---|---|---|
| Polyol | XP2645 | XP2645 | XP2470 | XP2470 | X 2695 | XP2695 |
| Polyisocyanate | a2)-5 | Ex. 7 | a2)-5 | Ex. 7 | a2)-5 | Ex. 7 |
| SiO2 content in the PIC % | 0 | 10 | 0 | 10 | 0 | 10 |
| Drying [h] | | | | | | |
| T1 | 2 | 2 | 1.5 | 1.5 | 1.5 | 1.5 |
| T2 | 5.5 | 5.5 | 4 | 5 | 4 | 4 |
| T3 | >6 | >6 | 5.5 | 5.5 | 5.5 | 5.5 |
| T4 | >6 | >6 | >6 | >6 | >6 | >6 |
| Layer thickness in μm | 46.0 | 48.0 | 60.0 | 60.0 | 52.0 | 60.0 |
| Gloss | 86.6 | 86.9 | 86.6 | 87.0 | 82.9 | 85.1 |
| Haze | 12.7 | 8.9 | 8.0 | 6.1 | 29.5 | 21.6 |
| Scratch resistance hammer test/steel wool | | | | | | |
| Residual gloss after exposure | 37.8 | 45.3 | 47.4 | 52.5 | 47.5 | 53.0 |
| Residual gloss after reflow (2 h 60° C.) | 75.4 | 80.3 | 77.6 | 79.3 | 72.1 | 81.5 |
| Rel. residual gloss after exposure [%] | 43.6 | 52.1 | 54.7 | 60.3 | 57.3 | 62.3 |
| Rel. residual gloss after reflow (2 h 60° C.) [%] | 87.1 | 92.4 | 89.6 | 91.1 | 87.0 | 95.8 |
| Pendulum hardness R.T. in sec. | | | | | | |
| 2 h R.T. | 30 | 24 | 25 | 18 | 27 | 21 |
| 1 d R.T. | 175 | 175 | 115 | 78 | 146 | 125 |
| 7 d R.T. | 184 | 184 | 110 | 73 | 128 | 113 |
| Scratch resistance Amtec Kistler | | | | | | |
| Residual gloss after 10 cycles | 64.5 | 72.0 | 61.8 | 62.8 | 60.2 | 67.4 |
| Residual gloss after reflow (2 h 60° C.) | 77.5 | 81.1 | 72.5 | 77.0 | 69.2 | 75.7 |
| Rel. residual gloss after exposure [%] | 74.5 | 82.9 | 71.4 | 72.2 | 72.6 | 79.2 |
| Rel. residual gloss after reflow (2 h 60° C.) [%] | 89.5 | 93.3 | 83.7 | 88.5 | 83.5 | 89.0 |
| Chemical resistance | | | | | | |
| Rating after 2 h\|1 d\|7 d | | | | | | |
| Water (1 h action) | 2/2/2 | 2/2/2 | 2/2/2 | 2/2/2 | 2/2/2 | 2/2/2 |
| Xylene | 4/2/1 | 4/2/1 | 4/1/1 | 4/1.5/ | 4/1/0 | 3/2/0 |
| | | | | 0.5 | | |
| MPA | 4/2/1 | 4/2/ | 4/1/1 | 4/1.5/ | 3.5/1.5/0 | 3/2/1 |
| | | 0.5 | | 0.5 | | |
| Premium gasoline | 4/2/ | 4/2/1 | 3/1.5/1 | 3/1.5/ | 3/2/ | 2.5/2/0 |
| | 0.5 | | | 0.5 | 0.5 | |
| Visual assessment after lacquering | OK | OK | OK | OK | slight | slight |
| | | | | | texture | texture |
| Visual assessment after drying | OK | OK | OK | OK | slight | slight |
| | | | | | texture | texture |

Rating chemical resistance:
0—good,
5—poor

### Comparison Examples 14.1, 14.3, 14.5

### Examples 14.2, 14.4, 14.6 According to the Invention

Clear-transparent, haze-free or low-haze films having an excellent film appearance and high degrees of gloss are obtained in all cases. The clear lacquers containing nano-modified hydrophilic polyisocyanates can be processed without difficulty; the nanoparticles do not adversely affect the film appearance and gloss at all.

The dry and wet scratching results of the clear lacquers nano-modified in that manner (measured as the relative gloss retention after exposure, see above) are about 5 to 15% above those of the unmodified variant in each case. The assessments of chemical resistance are likewise improved.

### Example 15

### Lacquer Formulations Single-Layer Covering Lacquer White

| | 1 | 2 | 3 | 4 | 5 | 6 |
|---|---|---|---|---|---|---|
| Polyol Bayhydrol type | XP | XP | XP | XP | XP | XP |
| | 2470 | 2470 | 2470 | 2470 | 2470 | 2470 |
| Solids % | 45 | 45 | 45 | 45 | 45 | 45 |
| OH % | 3.9 | 3.9 | 3.9 | 3.9 | 3.9 | 3.9 |
| Polyisocyanate | a2)-1 | Ex. 2 | a2)-2 | Ex. 4 | a2)-3 | Ex. 5 |
| Solids % | 100 | 100 | 100 | 100 | 100 | 100 |
| NCO % | 21.2 | 15.36 | 17.4 | 13.25 | 18.2 | 23 |
| SiO2 content in the PIC % | 0.0 | 10.0 | 0.0 | 10.0 | 0.0 | 10.0 |
| NCO:OH | 1.5 | 1.5 | 1.5 | 1.5 | 1.5 | 1.5 |
| Component 1 | | | | | | |
| Bayhydrol XP 2470 | 288.1 | 249.6 | 264.7 | 231.7 | 270.1 | 293.5 |
| Surfynol 104 BC Del. form | 6.5 | 6.5 | 6.5 | 6.5 | 6.5 | 6.5 |
| (50% BA) | | | | | | |
| Borchigel PW 25 Del. form | 0.9 | 0.9 | 0.9 | 0.9 | 0.9 | 0.9 |
| (25% PG/H2O) | | | | | | |
| Baysilone LA 200 (10% BG) | 5.5 | 5.5 | 5.5 | 5.5 | 5.5 | 5.5 |
| Borchigen SN 95 Del. form | 41.9 | 41.9 | 41.9 | 41.9 | 41.9 | 41.9 |
| (25% H2O) | | | | | | |
| Tronox R-KB-4 | 174.4 | 174.4 | 174.4 | 174.4 | 174.4 | 174.4 |
| Dist. H2O DIN 6 = 20 s | 15.0 | 20.7 | 11.0 | 14.7 | 11.4 | 20.1 |
| Total comp. 1 | 532.3 | 499.5 | 504.9 | 475.6 | 510.7 | 542.8 |
| Component 2 | | | | | | |
| a2)-1 (80% in butoxyl) | 110.5 | | | | | |
| Ex. 2 (80% in butoxyl) | | 132.1 | | | | |
| a2)-2 (80% in butoxyl) | | | 123.7 | | | |
| Ex. 4 (80% in butoxyl) | | | | 142.2 | | |
| a2)-3 (80% in butoxyl) | | | | | 120.6 | |
| Ex. 5 (80% in butoxyl) | | | | | | 105.2 |
| a2)-4 (80% in butoxyl) | | | | | | |
| Ex. 6 (80% in butoxyl) | | | | | | |
| a2)-5 (80% in butoxyl) | | | | | | |
| Ex. 7 (80% in butoxyl) | | | | | | |
| Dynasilan Glymo | 4.4 | 4.4 | 4.4 | 4.4 | 4.4 | 4.4 |
| Tinuvin 292 | 2.2 | 2.2 | 2.2 | 2.2 | 2.2 | 2.2 |
| Total comp. 1 + 2 | 649.4 | 638.2 | 635.2 | 624.4 | 637.9 | 654.6 |
| Demin. H2O visc, to MV | 20.0 | 22.3 | 28.2 | 28.3 | 26.3 | 20.4 |
| Spraying viscosity DIN4 in s | 25.0 | 25.0 | 24.0 | 25.0 | 23.0 | 25.0 |
| Solids in % | 58.7 | 59.2 | 57.0 | 58.4 | 57.4 | 57.7 |
| Nano content in the solid (%) | 0.0 | 2.4 | 0.0 | 2.6 | 0.0 | 1.9 |

Butoxyl: 3-Methoxy-n-butyl acetate

### Example 15—Continuation

### Lacquer Formulations Single-Layer Covering Lacquer White

| | 7 | 8 | 9 | 10 |
|---|---|---|---|---|
| Polyol Bayhydrol type | XP 2470 | XP 2470 | XP 2470 | XP 2470 |
| Solids % | 45 | 45 | 45 | 45 |
| OH % | 3.9 | 3.9 | 3.9 | 3.9 |
| Polyisocyanate | a2)-4 | Ex. 6 | a2)-5 | Ex. 7 |
| Solids % | 100 | 100 | 100 | 100 |
| NCO % | 16.2 | 12.34 | 20.6 | 16.14 |
| SiO2 content in the PIC % | 0.0 | 10.0 | 0.0 | 10.0 |
| NCO:OH | 1.5 | 1.5 | 1.5 | 1.5 |

Component 1

| | | | | |
|---|---|---|---|---|
| Bayhydrol XP 2470 | 256.1 | 223.2 | 284.7 | 255.6 |
| Surfynol 104 BC Del. form (50% BA) | 6.5 | 6.5 | 6.5 | 6.5 |
| Borchigel PW 25 Del. form (25% | 0.9 | 0.9 | 0.9 | 0.9 |
| PG/H2O) | | | | |
| Baysilone LA 200 (10% BG) | 5.5 | 5.5 | 5.5 | 5.5 |
| Borchigen SN 95 Del. form (25% | 41.9 | 41.9 | 41.9 | 41.9 |
| H2O) | | | | |
| Tronox R-KB-4 | 174.4 | 174.4 | 174.4 | 174.4 |
| Dist. H2O DIN 6 = 20 s | 10.0 | 10.1 | 14.7 | 14.7 |
| Total comp. 1 | 495.3 | 462.5 | 528.6 | 499.5 |

Component 2

| | | | | |
|---|---|---|---|---|
| a2)-1 (80% in butoxyl) | | | | |
| Ex. 2 (80% in butoxyl) | | | | |
| a2)-2 (80% in butoxyl) | | | | |
| Ex. 4 (80% in butoxyl) | | | | |
| a2)-3 (80% in butoxyl) | | | | |
| Ex. 5 (80% in butoxyl) | | | | |
| a2)-4 (80% in butoxyl) | 128.5 | | | |
| Ex. 6 (80% in butoxyl) | | 147.0 | | |
| a2)-5 (80% in butoxyl) | | | 112.4 | |
| Ex. 7 (80% in butoxyl) | | | | 128.8 |
| Dynasilan Glymo | 4.4 | 4.4 | 4.4 | 4.4 |
| Tinuvin 292 | 2.2 | 2.2 | 2.2 | 2.2 |
| Total comp. 1 + 2 | 630.4 | 616.1 | 647.6 | 634.9 |
| Demin. H2O visc. to MV | 29.3 | 30.5 | 20.3 | 21.5 |
| Spraying viscosity DIN4 in s | 24.0 | 23.0 | 22.0 | 24.0 |
| Solids in % | 57.2 | 58.6 | 58.7 | 59.7 |
| Nano content in the solid (%) | 0.0 | 2.7 | 0.0 | 2.3 |

Butoxyl: 3-Methoxy-n-butyl acetate

### Comparison Examples 15.1, 15.3, 15.5, 15.7, 15.9

### Examples 15.2, 15.4, 15.6, 15.8, 15.10 According to the Invention

The polyol mixture was placed in a reaction vessel in each case; the additives and pigment were added and the whole was mixed thoroughly, with stirring. Subsequent grinding of the pigment can be carried out in a powder mill or by means of a Skandex apparatus, grinding time from 30 to 60 minutes. The mixture was then adjusted to a runout viscosity of 20 seconds (DIN 6 beaker) with demineralised water. After a stirring time of one day (for deaeration), the polyisocyanate/solvent mixture was added, and the mixture was stirred thoroughly again and adjusted to a spraying viscosity of 25 seconds (DIN 4 beaker) with demineralised water.

The lacquer was then applied to the prepared substrate using a Sata Digital RP 2 gravity spray gun (1.4 mm nozzle) in 1.5 cross-coats. After an aeration time of 30 minutes, the lacquer was dried at 60° C. for 30 minutes. The dry layer thickness was in each case approximately 50 μm. The lacquer tests were carried out after 7 days, the anticorrosion tests after 10 days' storage at RT.

### Example 16a

### Lacquer Testing Single-Layer Covering Lacquers White from Example 15—Anticorrosive Properties

| | 1 | 2 | 3 | 4 | 5 | 6 | 7 | 8 | 9 | 10 |
|---|---|---|---|---|---|---|---|---|---|---|
| Polyol | XP 2470 | XP 2470 | XP 2470 | XP 2470 | XP 2470 | XP 2470 | XP 2470 | XP 2470 | XP 2470 | XP 2470 |
| Polyisocyanate | a2)-1 | Ex. 2 | a2)-2 | Ex. 4 | a2)-3 | Ex. 5 | a2)-4 | Ex. 6 | a2)-5 | Ex. 7 |
| SiO2 in the | 0.0 | 10.0 | 0.0 | 10.0 | 0.0 | 10.0 | 0.0 | 10.0 | 0.0 | 10.0 |
| PIC in % | | | | | | | | | | |
| Layer thickness | 48 | 51 | 43 | 50 | 49 | 50 | 43 | 47 | 43 | 49 |
| μm | | | | | | | | | | |
| Condensation | | | | | | | | | | |
| water test | | | | | | | | | | |
| after 7 d | 1/1 | 0/0 | 1/1 | 1/1 | 1/1 | 1/1 | 1/1 | 1/1 | 1/1 | 1/1 |
| after 14 d | 2/1-2 | 1/1 | 1/1-3 | 1/1 | 2/1-4 | 2/1-2 | 1/1 | 1/1-4 | 1/1 | 2/1 |
| after 21 d | 3/1-2 | 2/1-2 | 3/1-3 | 1/1-2 | 2/1-4 | 3/1-2 | 1/1 | 1/1-4 | 2/1-2 | 3/1-2 |
| after 35 d | 3/1-2 | 3/1-3 | 3/1-4 | 2/1-4 | 3/1-5 | 3/1-3 | 2/1-5 | 2/1-5 | 5/1-3 | 5/1-3 |
| after 42 d | 3/1-2 | 3/1-3 | 3/1-4 | 2/1-4 | 3/1-5 | 3/1-3 | 2/1-5 | 3/1-5 | | |
| after 49 d | 3/1-2 | 3/1-3 | 3/1-5 | 2/1-4 | 3/1-5 | 3/1-3 | 2/1-5 | 3/1-5 | | |
| after 56 d | 3/1-3 | 3/1-3 | 3/1-5 | 2/1-5 | 3/1-5 | 3/1-5 | 3/1-5 | 3/1-5 | | |
| after 70 d | 4/1-5 | 4/1-5 | 4/1-5 | 3/1-5 | 3/1-5 | 3/1-5 | 3/1-5 | 3/1-5 | | |
| after 84 d | | | | 3/1-5 | 4/1-5 | 3/1-5 | 3/1-5 | 3/1-5 | | |
| after 39 d | | | | | | | | | | |
| Salt spray test | | | | | | | | | | |
| after 3 d | 5 | 3 | 7 | 3 // 1/1 // 1 | 8 | 5 | 7 | 5 | 10 // 1/1 // 1 | 5 |
| after 10 d | 20 | 12 | 35 | 18 // 1/1 // 1 | 15 | 18//1/1-2 //1 | 30 | 20//1/1-2//1 | 20 // 1/1 // 1 | 12 |
| after 14 d | 30 | 18 | 50 // 1/1 // 1 | 22 | 22 | 25//1/1-5//1 | 50 | 25//1/1-2/1 | 30 | 20 |
| after 21 d | 35 // 1/1-5 | 20 | 5/1-5 // 1 | 5/1-5 // 1 | 32 | 3/1-5 // 1 | 4/1-5 | 5/1-5 // 1 | 50 //1/1-5 // 1 | 25 // 1/1-3 |
| after 28 d | 4/1-5 | 30 | | | 3/1-5 | 3/1-5 // 1 | | | 5/1-5 // 1 | 30 // 1/1-5 |
| after 35 d | | 3/1-5 | | | 4/1-5 | 5/1-5 | | | | 3/1-5 |
| after 42 d | | 35 // 4/1-5 | | | | | | | | 4/1-5 |

### Example 16b

### Lacquer Testing Single-Layer Covering Lacquers White from Example 15—Other Lacquer Properties

| | 1 | 2 | 3 | 4 | 5 | 6 | 7 | 8 | 9 | 10 |
|---|---|---|---|---|---|---|---|---|---|---|
| Polyol | XP 2470 | XP 2470 | XP 2470 | XP 2470 | XP 2470 | XP 2470 | XP 2470 | XP 2470 | XP 2470 | XP 2470 |
| Polyisocyanate | a2)-1 | Ex. 2 | a2)-2 | Ex. 4 | a2)-3 | Ex. 5 | a2)-4 | Ex. 6 | a2)-5 | Ex. 7 |
| SiO2 in the PIC in % | 0.0 | 10.0 | 0.0 | 10.0 | 0.0 | 10.0 | 0.0 | 10.0 | 0.0 | 10.0 |
| Layer thickness μm | 48 | 51 | 43 | 50 | 49 | 50 | 43 | 47 | 43 | 49 |
| Pendulum hardness | | | | | | | | | | |
| +2 h | 71 | 59 | 39 | 25 | 46 | 47 | 36 | 27 | 91 | 61 |
| after 1 d | 132 | 121 | 93 | 64 | 103 | 78 | 85 | 72 | 148 | 124 |
| after 7 d | 158 | 152 | 124 | 96 | 135 | 100 | 119 | 106 | 169 | 156 |
| Resistance after | | | | | | | | | | |
| drying, 1 d, 7 d | | | | | | | | | | |
| dist. H2O, 1 h | 4-5/3/1 | 4-5/3/1 | 4-5/3/1 | 4-5/3/1 | 4-5/2/1 | 4-5/3/1 | 4-5/3/1 | 4-5/3/1 | 4-5/2/1 | 4-5/2/1 |
| Super gasoline, 10 min | 5/3/2 | 5/3-4/2 | 5/4-5/2 | 5/4-5/1-2 | 5/3/2 | 5/4/2 | 5/4/2 | 5/4-5/2 | 5/2/2 | 5/2/2 |
| MPA, 10 min | 5/3/1-2 | 5/3-4/1 | 5/4-5/1 | 5/4-5/1 | 5/3/1 | 5/4/2 | 5/4/1-2 | 5/4-5/2 | 5/2/1-2 | 5/2/1-2 |
| Xylene, 10 min | 5/3/1-2 | 5/3-4/1 | 5/4-5/1 | 5/4-5/1 | 5/3/1 | 5/4/2 | 5/4/1-2 | 5/4-5/1-2 | 5/2/1-2 | 5/2/1-2 |
| Gloss 20° | 81.0 | 78.9 | 82.7 | 80.3 | 81.4 | 77.9 | 78.9 | 77.7 | 79.3 | 77.5 |
| Haze | 4.1 | 4.0 | 3.4 | 3.4 | 4.0 | 3.9 | 4.0 | 4.0 | 4.9 | 5.5 |
| Hammer scratching steel wool | | | | | | | | | | |
| Residual gloss after | 79.5 | 78.7 | 81.3 | 79.6 | 80.1 | 76.0 | 78.1 | 77.0 | 77.9 | 77.1 |
| 10 to-and-fro strokes | | | | | | | | | | |
| Rel. residual gloss after | 98.1 | 99.7 | 98.3 | 99.1 | 98.4 | 97.6 | 99.0 | 99.1 | 98.2 | 99.5 |
| 10 to-and-fro strokes (%) | | | | | | | | | | |

### Example 16c

### Lacquer Testing Single-Layer Covering Lacquers White from Example 15—UV Weathering Cam 180

| | 1 | 2 | 3 | 4 | 5 | 6 | 7 | 8 | 9 | 10 |
|---|---|---|---|---|---|---|---|---|---|---|
| Polyol | XP 2470 | XP 2470 | XP 2470 | XP 2470 | XP 2470 | XP 2470 | XP 2470 | XP 2470 | XP 2470 | XP 2470 |
| Polyisocyanate | a2)-1 | Ex. 2 | a2)-2 | Ex. 4 | a2)-3 | Ex. 5 | a2)-4 | Ex. 6 | a2)-5 | Ex. 7 |
| SiO2 in the PIC in % | 0.0 | 10.0 | 0.0 | 10.0 | 0.0 | 10.0 | 0.0 | 10.0 | 0.0 | 10.0 |
| Layer thickness μm | 48 | 51 | 43 | 50 | 49 | 50 | 43 | 47 | 43 | 49 |
| UV accelerated weathering | | | | | | | | | | |
| CAM 180 | | | | | | | | | | |
| Gloss 60° | | | | | | | | | | |
| Starting value | 92 | 91 | 92 | 92 | 93 | 91 | 89 | 90 | 92 | 91 |
| 250 h | 90 | 89 | 88 | 86 | 89 | 88 | 86 | 87 | 92 | 90 |
| 500 h | 90 | 88 | 87 | 86 | 89 | 88 | 86 | 86 | 91 | 89 |
| 750 h | 89 | 87 | 87 | 86 | 88 | 87 | 84 | 84 | 90 | 88 |
| 1000 h | 86 | 85 | 83 | 83 | 85 | 84 | 82 | 81 | 87 | 86 |
| 1250 h | 87 | 85 | 84 | 83 | 86 | 86 | 82 | 83 | 88 | 86 |
| 1500 h | 86 | 84 | 83 | 83 | 85 | 85 | 82 | 81 | 85 | 87 |
| 1750 h | 84 | 82 | 81 | 81 | 84 | 83 | 80 | 78 | 86 | 85 |
| delta E | | | | | | | | | | |
| 250 h | 0.1 | 0.1 | 0.2 | 0.1 | 0.1 | 0.3 | 0.3 | 0.3 | 0.1 | 0.2 |
| 500 h | 0.2 | 0.1 | 0.3 | 0.1 | 0.1 | 0.3 | 0.4 | 0.2 | 0.1 | 0.1 |
| 750 h | 0.4 | 0.3 | 0.4 | 0.3 | 0.3 | 0.4 | 0.4 | 0.4 | 0.3 | 0.4 |
| 1000 h | 0.5 | 0.4 | 0.5 | 0.5 | 0.5 | 0.6 | 0.6 | 0.5 | 0.5 | 0.5 |
| 1250 h | 0.5 | 0.5 | 0.6 | 0.4 | 0.5 | 0.6 | 0.6 | 0.5 | 0.5 | 0.4 |
| 1500 h | 0.8 | 0.6 | 0.7 | 0.5 | 0.6 | 0.7 | 0.7 | 0.6 | 0.7 | 0.5 |
| 1750 h | 0.7 | 0.5 | 0.6 | 0.5 | 0.6 | 0.6 | 0.6 | 0.6 | 0.6 | 0.5 |

### Comparison Examples 16.1, 16.3, 16.5, 16.7, 16.9

### Examples 16.2, 16.4, 16.6, 16.8, 16.10 According to the Invention

Rating of the salt spray test: blisters in the total area of the DIN cut (in mm)//blisters: quantity/size//rust (0—good 5—poor)

Rating of the condensation water test: blisters: quantity/size (0—good 5—poor)

Haze-free films having a good film appearance and high degrees of gloss are obtained in all cases. The clear lacquers containing nano-modified hydrophilic polyisocyanates can be processed without difficulty; the nanoparticles do not adversely affect the film appearance and the gloss at all.

The improvement in the anticorrosive properties of the lacquer films, in particular in the field of salt spray resistance, is clearly visible. The use of the nano-modified polyisocyanates according to the invention leads to significantly less damage as compared with the unmodified polyisocyanates under the same exposure, or accordingly permits considerably longer exposure times until corresponding damage is present.

The results of the CAM 180 UV accelerated weathering (Examples 16c.1 to 16c.10) show no negative effects of the nano-modified polyisocyanates according to the invention on the yellowing tendency (delta E) or on the reduction in gloss of the tested lacquer films. In some cases, a slightly positive trend on the yellowing of the lacquer film can be observed.

### Example 17

### Lacquer Formulations Single-Layer Covering Lacquer White, Hydrophobic Polyisocyanates a1)

Preparation was carried out analogously to Example 15.

| | 1 | 2 | 3 | 4 |
|---|---|---|---|---|
| Polyol Bayhydrol type | XP 2470 | XP 2470 | XP 2470 | XP 2470 |
| Solids % | 45 | 45 | 45 | 45 |
| OH % | 3.9 | 3.9 | 3.9 | 3.9 |
| Polyisocyanate | a1)-2 | Ex. 11 | a1)-1 | Ex. 10 |
| Solids % | 100 | 100 | 100 | 100 |
| NCO % | 23.5 | 15.9 | 23 | 12.4 |
| SiO2 content in the PIC % | 0.0 | 10.0 | 0.0 | 10.0 |
| NCO:OH | 1.5 | 1.5 | 1.5 | 1.5 |

Component 1

| | | | | |
|---|---|---|---|---|
| Bayhydrol XP 2470 | 300.0 | 253.8 | 297.5 | 223.7 |
| Surfynol 104 BC Del. form (50% BA) | 6.5 | 6.5 | 6.5 | 6.5 |
| Borchigel PW 25 Del. form (25% | 0.9 | 0.9 | 0.9 | 0.9 |
| PG/H2O) | | | | |
| Baysilone LA 200 (10% BG) | 5.5 | 5.5 | 5.5 | 5.5 |
| Borchigen SN 95 Del. form (25% H2O) | 41.9 | 41.9 | 41.9 | 41.9 |
| Tronox R-KB-4 | 174.4 | 174.4 | 174.4 | 174.4 |
| Dist. H2O DIN 6 = 20 s | 18.3 | 12.7 | 13.6 | 10.0 |
| Total comp. 1 | 547.5 | 495.7 | 540.3 | 462.9 |

Component 2

| | | | | |
|---|---|---|---|---|
| a1)-2 (80% in butoxyl) | 103.8 | | | |
| Ex. 11 (80% in butoxyl) | | 129.8 | | |
| a1)-1 (80% in butoxyl) | | | 105.2 | |
| Ex. 10 (80% in butoxyl) | | | | 146.7 |
| Dynasilan Glymo | 4.4 | 4.4 | 4.4 | 4.4 |
| Tinuvin 292 | 2.2 | 2.2 | 2.2 | 2.2 |
| Total comp. 1 + 2 | 657.9 | 632.1 | 652.1 | 616.2 |
| Demin. H2O visc. to MV | 15.9 | 17.8 | 15.9 | 19.0 |
| Spraying viscosity DIN4 in s | 21.0 | 23.0 | 23.0 | 26.0 |
| Solids in % | 59.5 | 61.6 | 60.1 | 63.0 |
| Nano content in the solids (%) | 0.0 | 2.3 | 0.0 | 2.6 |

### Comparison Examples 17.1, 17.3

### Examples 17.2, 17.4 According to the Invention

### Example 18a

### Lacquer testing single-layer covering lacquers white from Example 17—anticorrosive properties

| | 1 | 2 | 3 | 4 |
|---|---|---|---|---|
| Polyol | XP 2470 | XP 2470 | XP 2470 | XP 2470 |
| Polyisocyanate | a1)-2 | Ex. 11 | a1)-1 | Ex. 10 |
| SiO2 in the PIC in % | 0.0 | 10.0 | 0.0 | 10.0 |
| Layer thickness μm | 51 | 52 | 55 | 49 |

Condensation water test

| | | | | |
|---|---|---|---|---|
| after 7 d | 0/0 | 1/1 | 1/1 | 1/1 |
| after 14 d | 1/1 | 1/1 | 1/1 | 2/1 |
| after 21 d | 2/1 | 1/1 | 1/1 | 2/1 |
| after 35 d | 2/1 | 1/1 | 3/1-2 | 2/1-2 |
| after 42 d | 3/1-5 | 2/1 | 3/1-2 | 2/1-2 |
| after 49 d | 3/1-5 | 3/1-2 | 3/1-2 | 3/1-2 |
| after 56 d | 3/1-5 | 3/1-3 | 3/1-2 | 3/1-3 |
| after 70 d | 3/1-5 | 3/1-5 | 3/1-5 | 3/1-5 |
| after 84 d | 3/1-5 | 3/1-5 | 4/1-5 | 3/1-5 |
| after 39 d | | | | |

Salt spray test

| | | | | |
|---|---|---|---|---|
| after 3 d | 15 | 15 | 15 | 10 |
| after 10 d | 28 | 30 | 24 | 18 |
| after 14 d | 35//1/1-3 | 35//1/1-2 | 30 | 22//1/1 |
| after 21 d | 50//1/1-5 | 40//1/1-3 | 30//1/1-5 | 25//1/1//1 |
| after 28 d | 5/1-5 | 45//1/1-5 | 3/1-5 | 50//1/1//1 |
| after 35 d | | 3/1-5 | 4/1-5 | 3/1-5 |
| after 42 d | | 4/1-5 | | 4/1-5 |

### Example 18b

### Lacquer Testing Single-Layer Covering Lacquers White from Example 17—Other Properties

| | 1 | 2 | 3 | 4 |
|---|---|---|---|---|
| Polyol | XP 2470 | XP 2470 | XP 2470 | XP 2470 |
| Polyisocyanate | a1)-2 | Ex. 11 | a1)-1 | Ex. 10 |
| SiO2 in the PIC in % | 0.0 | 10.0 | 0.0 | 10.0 |
| Layer thickness μm | 51 | 52 | 55 | 49 |

Pendulum hardness

| | | | | |
|---|---|---|---|---|
| +2 h | 64 | 38 | 51 | 26 |
| after 1 d | 142 | 112 | 118 | 86 |
| after 7 d | 169 | 160 | 150 | 153 |

Resistance after drying, 1 d, 7 d

| | | | | |
|---|---|---|---|---|
| dist. H2O, 1 h | 4-5/3/1 | 4-5/2/1 | 4-5/2-3/1 | 4-5/2/1 |
| Super gasoline, 10 min | 5/3/2 | 5/3/2 | 5/2-3/2 | 5/4/2 |
| MPA, 10 min | 5/3/1-2 | 5/3/1 | 5/2-3/1 | 5/4/2 |
| Xylene, 10 min | 5/3/1-2 | 5/3/2 | 5/2-3/1 | 5/4/2 |
| Gloss 20° | 77.0 | 78.0 | 74.1 | 77.2 |
| Haze | 6.0 | 5.5 | 8.3 | 5.2 |

Hammer scratching steel wool

| | | | | |
|---|---|---|---|---|
| Residual gloss after 10 to-and-fro strokes | 76.4 | 76.0 | 73.1 | 75.3 |
| Rel. residual gloss after 10 to-and-fro | 99.2 | 97.4 | 98.7 | 97.5 |
| strokes(%) | | | | |

### Example 18c

### Lacquer Testing Single-Layer Covering Lacquers White from Example 17—UV Weathering CAM 180

| 2K WB single-layer covering lacquer | | | |
|---|---|---|---|
| white | | | |
| 1 | 2 | 3 | 4 |

Example xx - Hydrophobic PICs

| | | | | |
|---|---|---|---|---|
| Polyol | XP 2470 | XP 2470 | XP 2470 | XP 2470 |
| Polyisocyanate | a1)-2 | Ex. 11 | a1)-1 | Ex. 10 |
| SiO2 in the PIC in % | 0.0 | 10.0 | 0.0 | 10.0 |
| Layer thickness μm | 51 | 52 | 55 | 49 |

UV accelerated weathering CAM 180
Gloss 60°

| | | | | |
|---|---|---|---|---|
| Starting value | 91 | 91 | 91 | 92 |
| 250 h | 90 | 89 | 87 | 89 |
| 500 h | 89 | 88 | 87 | 88 |
| 750 h | 89 | 88 | 88 | 87 |
| 1000 h | 85 | 86 | 84 | 84 |
| 1250 h | 87 | 83 | 86 | 84 |
| 1500 h | 86 | 87 | 86 | 84 |
| 1750 h | 85 | 84 | 85 | 82 |

delta E

| | | | | |
|---|---|---|---|---|
| 250 h | 0.1 | 0.0 | 0.0 | 0.1 |
| 500 h | 0.1 | 0.3 | 0.1 | 0.2 |
| 750 h | 0.3 | 0.4 | 0.3 | 0.4 |
| 1000 h | 0.5 | 0.5 | 0.5 | 0.3 |
| 1250 h | 0.5 | 0.5 | 0.5 | 0.4 |
| 1500 h | 0.6 | 0.6 | 0.7 | 0.6 |
| 1750 h | 0.5 | 0.5 | 0.5 | 0.5 |

### Comparison Examples 18.1, 18.3

### Examples 18.2, 18.4 According to the Invention

Rating of the salt spray test: blisters in the total area of the DIN cut (in mm)//blisters: quantity/size//rust (0—good 5—poor)

Rating of the condensation water test: blisters: quantity/size (0—good 5—poor)

The clear lacquers containing nano-modified hydrophilic polyisocyanates can be processed without difficulty; the nanoparticles do not adversely affect the film appearance and the gloss at all.

The improvement in the anticorrosive properties of the lacquer films, in particular in the field of salt spray resistance, is clearly visible. The use of the nano-modified polyisocyanates according to the invention leads to significantly less damage as compared with the unmodified polyisocyanates under the same exposure, or accordingly permits considerably longer exposure times until corresponding damage is present.

The results of the CAM 180 UV accelerated weathering (Example 18c.1 to 18c.4) show no negative effects of the nano-modified polyisocyanates according to the invention on the yellowing tendency (delta E) or on the reduction in gloss of the tested lacquer films.

1.-14. (canceled)

15. A coating composition comprising
A) from 10 to 90 wt. % of an aqueous, hydroxy- and/or amino-functional resin dispersion,
B) from 10 to 90 wt. % of a nanoparticle-modified polyisocyanate, and
C) from 0 to 60 wt. % of further auxiliary substances and additives known in lacquer technology,
the percentages being based on solids in the total composition.

16. The coating composition according to claim 15, wherein the aqueous, hydroxy- and/or amino-functional resin dispersion A) comprises, based on solid resin, a content of hydroxyl groups of from 0.5 to 7.0 wt. % and have acid numbers of less than 50 mg KOH/g.

17. The coating composition according to claim 15, wherein the nanoparticle-modified polyisocyanate B) comprises nanoparticle-modified polyisocyanate mixtures based on aliphatic, cycloaliphatic, araliphatic and/or aromatic diisocyanates having a mean NCO functionality of at least 2.1 and a content of isocyanate groups (calculated as NCO; molecular weight=42) of from 2.0 to 24.0 wt. %, which are obtained by reaction of
a1) a hydrophobic polyisocyanate component and/or
a2) a hydrophilically modified polyisocyanate component with
b) alkoxysilanes of formula (I)
Q-Z—SiXₙY₃₋ₙ (I)
wherein
Q represents a group reactive towards isocyanates,
X represents a hydrolysable group,
Y represents identical or different alkyl groups,
Z represents a C₁-C₁₂-alkylene group and
n is an integer from 1 to 3,
and subsequent dispersion of
c) inorganic particles, which are optionally surface-modified, and having a mean particle size, determined by means of dynamic light scattering in particle number weighting, of less than 200 nm
and optionally addition of
d) solvents.

18. The coating composition according to claim 17, wherein the hydrophobic polyisocyanate component a1) comprises polyisocyanates or polyisocyanate mixtures having solely aliphatically and/or cycloaliphatically bonded isocyanate groups.

19. The coating composition according to claim 17, wherein the hydrophilically modified polyisocyanate component comprises hydrophilically modified polyisocyanates at least comprising a hydrophobic starting polyisocyanate a1) and at least one ionic and/or non-ionic emulsifier e).

20. The coating composition according to claim 19, wherein the emulsifier e) comprises reaction products e1) of the polyisocyanates a1) with hydrophilic polyether alcohols.

21. The coating composition according to claim 19, wherein the emulsifier e) comprises reaction products e2) of monomeric diisocyanates or diisocyanate mixtures with pure polyethylene glycol monomethyl ether alcohols which contain, in the statistical mean, from 5 to 50, ethylene oxide units.

22. The coating composition according to claim 21, wherein the emulsifier e) comprises reaction products e3) which are obtained by mixing and reacting the polyether urethane emulsifiers e2) with the polyisocyanates a1) in the presence of catalysts with allophanate formation.

23. The coating composition according to claim 19, wherein the emulsifier e) comprises reaction products e4) of the polyisocyanates a1) with 2-(cyclohexylamino)-ethanesulfonic acid and/or 3-(cyclohexylamino)-propanesulfonic acid.

24. The coating composition according to claim 19, wherein the emulsifier e) comprises alkylphenol polyglycol ether phosphates, alkylphenol polyglycol ether phosphonates, fatty alcohol polyglycol ether phosphates, fatty alcohol polyglyol ether phosphonates, alkylphenol polyglycol ether sulfates, fatty alcohol polyglycol ether sulfates neutralised with tertiary amines, or mixtures thereof.

25. The coating composition according to claim 17, wherein, in the alkoxysilanes according to formula (I),
X represents an alkoxy or hydroxy group,
Y represents a linear or branched C₁-C₄-alkyl group,
Z represents a linear or branched C₁-C₄-alkylene group, and
Q represents a group that reacts with isocyanates to form urethane, urea or thiourea.

26. The coating composition according to claim 17, wherein the inorganic particles c) comprise inorganic oxides, mixed oxides, hydroxides, sulfates, carbonates, carbides, borides and nitrides of elements of main groups II to IV and/or elements of subgroups I to VIII of the periodic system, including the lanthanides, or mixtures thereof.

27. The coating composition according to claim 17, wherein the inorganic particles c) have been surface-modified.

28. A coating obtained from the coating composition according to claim 15.
